(19) United States
(12) Patent Application Publication
(10) Pub. No.: US 2025/0079047 A1
(43) Pub. Date: Mar. 6, 2025

(54) DEFECT CURRENT CONTROL IN HIGH TEMPERATURE SUPERCONDUCTOR STRUCTURES

(71) Applicant: Massachusetts Institute of Technology, Cambridge, MA (US)

(72) Inventors: Zachary HARTWIG, Jamaica Plain, MA (US); Nicolò RIVA, Baceno (VB) (IT); Richard T. IBEKWE, Cambridge, MA (US)

(73) Assignee: Massachusetts Institute of Technology, Cambridge, MA (US)

(21) Appl. No.: 18/825,963

(22) Filed: Sep. 5, 2024

Related U.S. Application Data
(60) Provisional application No. 63/580,894, filed on Sep. 6, 2023.

(51) Int. Cl. H01B 12/02; H01B 13/00

(52) U.S. Cl. CPC H01B 12/02; H01B 13/0006

(57) ABSTRACT

Described is a high-temperature superconductor (HTS) cable, comprising a plurality of HTS tapes, wherein all or part of a cross-section of at least one of the HTS tapes are removed to reduce the current carrying capacity of the HTS tape. Also described is a method for shaping the current density of a high-temperature superconductor (HTS) cable, wherein the HTS current density is carried by HTS tapes, and wherein the method comprises selective mechanical removal of all or part of the cross section of one or more of HTS tapes.

### CROSS REFERENCE TO RELATED APPLICATIONS

This application claims the benefits of U.S. Provisional Application No. 63/580,894 filed on Sep. 6, 2023, the entire contents of which are hereby incorporated herein by reference.

### STATEMENT REGARDING FEDERALLY SPONSORED RESEARCH

Not applicable.

### BACKGROUND

Defects in high temperature superconducting (HTS) tapes have been induced with chemical etching or laser skiving. Such processes, however, require special equipment, can be labor-intensive, and are not readily scalable to large volumes.

### SUMMARY

Described herein is a technique for abrasively inducing one or more partial defects in high temperature superconducting (HTS) tapes. Abrasive technique may include, but are not limited to, mechanically cutting, grinding or rubbing the HTS tape to form one or more structural defects in an HTS tape. Such abrasive and/or mechanical approaches improve simplicity, ease of fabrication, tolerances, and repeatability for inducing structural defects in HTS tapes. Providing structural defects in an HTS tape via abrasive and/or mechanical techniques removes material from all layers of the HTS tape.

This is in contrast to conventional approaches such as chemical and laser bridging techniques, in which less than all layers are removed. For example, in an HTS tape comprising rare-earth barium copper oxide (REBCO), only REBCO, copper, and silver layers on one side of the HTS tape are removed, leaving portions the rest of the cross section of the HTS tape intact.

In one aspect, a method for mechanically inducing intentional defects in an HTS cable includes providing notches an HTS tape. In embodiments, the notches may be provided having a rectangular shape. In embodiments, the notches may be provided by filing an HTS tape with a file. In embodiments, a file having a width of about 1 mm may be used. This approach allows a local critical current of an HTS tape to be finely tuned.

Also described is a technique for using defects as a tool for controlling current distribution in superconducting devices comprising an HTS material such as HTS cables and HTS magnets.

Also described are examples of applications of defects (of many possible applications of defects). In some examples, a method for using defects to force a more uniform current distribution in a REBCO cable are described.

In accordance with one aspect of the concepts described herein, described is a high-temperature superconductor (HTS) cable, comprising a plurality of layers of HTS tape with one or more of the layers of HTS tape having all or part of a cross-section thereof removed.

With this particular arrangement, an HTS cable having a shaped current density is provided. By selectively removing all or part of a cross section of one or more of the one or more layers of HTS tape, a current carrying capacity characteristic of the HTS tape is affected. By selecting one or more particular locations of an HTS tape in which to provide mechanical defects, an HTS tape may be provided having a desired current carrying capacity characteristic. By arranging one or more such HTS tapes into an HTS tape stack and fabricating an HTS cable comprising such an HTS tape stack, an HTS cable having a shaped current density may be provided.

In accordance with a further aspect of the concepts described herein, a method of shaping the current density of a high-temperature superconductor (HTS) cable comprising one or more of layers of HTS tape arranged in an HTS tape stack includes selectively removing all or a part of a cross section of one or more of the one or more HTS tapes in the HTS tape stack.

With this particular arrangement, a method for controlling current distribution in an HTS table by selectively removing all or a part of a cross section of one or more of the one or more HTS tapes in the HTS tape stack to force greater current uniformity at low operating currents in the HTS cable is provided.

In accordance with a further aspect of the concepts described herein, a high-temperature superconductor (HTS) cable comprising a plurality of HTS tapes arranged to provide an HTS tape stack with at least one of the HTS tapes having a portion thereof removed to reduce the current carrying capacity of the tape.

With this particular arrangement, an HTS cable having a controlled current distribution is provided. Including in the HTS cable at least one HTS tape having a portion thereof removed to reduce the current carrying capacity of the tape directs greater current uniformity at low operating currents in the HTS cable.

In accordance with a further aspect of the concepts described herein, a method for predicting and interpreting behavior of an HTS cable having intentionally introduced mechanical defects includes performing circuit modeling of an HTS cable with several different defect configurations and selecting the configuration with the desired current distribution, a process that can be performed iteratively and algorithmically.

With this particular arrangement, a technique for controlling current distribution in an HTS cable by forcing greater current uniformity at low operating currents in the HTS cable is provided.

It should be noted that this Summary introduces a selection of concepts in simplified form that are described further below in the Detailed Description. This Summary is not intended to identify all essential features of the broad concepts described herein, nor is this Summary intended to limit the scope of the claimed subject matter.

### BRIEF DESCRIPTION OF THE DRAWINGS

The following Detailed Description references the accompanying drawings which form a part of this application, and which show, by way of illustration, specific example implementations. Other implementations may be made without departing from the scope of the disclosure.

FIG. 1 is a method for making a high temperature superconductor (HTS) cable comprising an HTS tape stack;

FIG. 2 is a method for determining a location at which to introduce a structural defect in one or more portions of an HTS tape;

FIG. 3A is a perspective view of an HTS tape;

FIG. 3B is a top view of an HTS tape having a pair of mechanical defects provided therein;

FIG. 3C illustrates a mechanical technique for forming a mechanical defect in one or more HTS tapes;

FIG. 4 is a perspective view of a portion of an HTS cable having an HTS tape stack with a pair of mechanical defects provided therein;

FIG. 5A (FIG. 2.16) is a top view of an example HTS cable which includes an HTS tape stack having one or more mechanical defects provided therein;

FIG. 5B is (FIG. 2.16) is a schematic diagram of a middle plane of a circuit model of the HTS cable of FIG. 5A;

FIG. 5C is (FIG. 2.16) is an enlarged view of a node portion of the schematic of FIG. 5B;

FIGS. 6A-6D are a series of schematic diagrams of a cross section of the cable of FIG. 5A, showing how the cable is segmented into circuit resistors and Biot-Savart current filaments;

FIG. 7A is a top view of an HTS tape having a defect;

FIG. 7B is a plot of voltage as a function of current for a REBCO tape with no defect and a REBCO tape with a 40% defect;

FIG. 8 is a cross-sectional view of an HTS cable with Tape configuration B;

FIG. 9A is a diagrams of an HTS cable with tape configuration A having no-defects;

FIG. 9B is a diagram of an HTS cable with tape configuration B having no-defects;

FIG. 9C is a diagram of a defect-seeded HTS cable with tape configuration B and having full defects in some tapes and partial defects in other tapes;

FIGS. 9D-9F are plots of current uniformity (defined as 1-RMSR) as a function of axial position at various operating currents predicted by the model for the cables of FIGS. 9A-9C, respectively.

FIG. 10A, is a diagram of an HTS cable having no-defects;

FIGS. 10B, 10C are plots of current distribution as a function of operating current in the cables of FIG. 10A;

FIG. 10D is a diagram of a defect-seeded HTS cable;

FIGS. 10E, 10F are plots of current distribution as a function of operating current in the cables of FIG. 10D;

FIG. 11 is a diagram of a defect-seeded configuration B HTS cable;

FIG. 11A is a plot of total power dissipation as a function of operating current for the defect-seeded configuration B cable of FIG. 11;

FIG. 11B is a plot of total defect-induced power dissipation as a function of operating current for the defect-seeded configuration B cable of FIG. 11;

FIG. 11C is a plot of total defect-induced power dissipation factor with respect to no-defect cable as a function of operating current for the defect-seeded configuration B cable of FIG. 11;

FIG. 11D is a plot of volumetric power dissipation density at the critical current of the cable as a function of axial position for the defect-seeded configuration B cable of FIG. 11;

FIG. 12A is schematic diagram of defect configuration in a 50-tape defect-seeded cable with tape configuration B-extended;

FIG. 12B is an enlarge view of a portion of the HTS cable of FIG. 12A;

FIG. 13 is a plot of current distribution RMSR as a function of operating current for both a no-defect HTS cable and a defect-seeded 50-tape configuration B-extended HTS cable.

FIG. 14 is a diagram of a defect-seeded 50-tape configuration B-extended HTS cable;

FIG. 14A is a plot of total power dissipation as a function of operating current for the defect-seeded 50-tape configuration B-extended HTS cable of FIG. 14;

FIG. 14B is a plot of total defect-induced power dissipation as a function of operating current for the defect-seeded 50-tape configuration B-extended HTS cable of FIG. 14;

FIG. 14C is a plot of total defect-induced power dissipation factor with respect to no-defect cable as a function of operating current for the defect-seeded 50-tape configuration B-extended HTS cable of FIG. 14; and

FIG. 14D is a plot of volumetric power dissipation density at 1.11 I_{c} of the cable as a function of axial position for the defect-seeded 50-tape configuration B-extended HTS cable of FIG. 14.

FIG. 15A is cross sectional view of an HTS cable;

FIG. 15B is an enlarged view of a portion of an HTS layer included in the HTS cable of FIG. 15A;

FIG. 15C is an enlarged portion of the HTS layer illustrated in FIG. 15B;

FIG. 16A is a plot of electric field at an axial midpoint of an HTS cable vs. operating current for a model and an experiment of an HTS cable with and without an HTS layer having a buffer layer;

FIG. 16B is a plot of current fraction as a function of operating current for an experimental set up;

FIG. 16C is a plot of current fraction as a function of operating current for the model without the buffer layer;

FIG. 16D is a plot of current fraction as a function of operating current for the model with the buffer layer;

FIG. 17A is a plot of critical current as a function of axial position for model REBCO tape reels with baseline I_{c}=115.7 A and added Gaussian distribution (mean of 0 A; standard deviation 0%, 2%, and 5% of baseline I_{c});

FIG. 17B is a plot of electric field at an axial midpoint as a function of operating current for the HTS cable;

FIGS. 17C-17E are a series of plots of current fraction as a function of operating current for the HTS cable; and

FIG. 17E is a plot of current fraction as a function of operating current for the HTS cable for the three I_{c} distribution cases.

### DETAILED DESCRIPTION

Before describing the use of intentionally placed mechanical defects in a high temperature superconductor (HTS) tape to control distribution in an HTS structure, some introductory concepts and terminology are explained.

In an HTS cable or an HTS magnet, active superconducting components comprise a plurality of layers of HTS material. Such HTS material is often in the form of ribbon-shaped wires often referred to as an HTS tape. In embodiments, two or more HTS tapes may be stacked together to form an HTS “tape stack.” Such HTS tape stacks may be included as part of an HTS cable or an HTS magnet. In an HTS cable or magnet, the active superconducting component is a layer of HTS tape (or a plurality of layers of HTS tapes) stacked tightly together with other HTS tapes which form the HTS tape stack.

As will be described in detail hereinbelow, one or more mechanical defects are induced in one or more HTS tapes by abrasive or mechanical removal of part of a cross section of one or more of the HTS tapes. HTS tapes having such mechanical defects may be included in an HTS tape stack.

To control electric current distribution within high-temperature superconductor (HTS) tapes, cables and magnets such mechanical defects are intentionally induced in selected regions of one or more layers of HTS tape within the HTS cable or HTS magnet. Introduction of mechanical defects in an HTS tape locally reduces the current carrying capacity (“critical current”) of the HTS tape, causing current to be driven into adjacent HTS tapes (e.g. as may be in an HTS tape stack) within an HTS cable or HTS magnet. By strategically inducing mechanical defects in certain (one or more) layers of HTS tape within an HTS tape stack and by controlling the type of mechanical defect (e.g., the physical configuration and dimensions of the mechanical defect) and the density of mechanical defects—a current density characteristic across a stack of HTS tapes may be shaped to affect or tune the performance of an HTS cable or an HTS magnet. Thus, intentional introduction of mechanical defects in one or more HTS tapes within an HTS tape stack provides a technique for precisely tuning a current distribution within the HTS tape stack thereby improving performance of an HTS cable by, for instance, improving current uniformity over shorter distances and at lower operating currents.

Also described herein is a technique for predicting the defect distribution required to cause a desired modification to the current distribution within a cable or magnet.

The intentional creation of defects by an abrasive process. Abrasive processes or techniques may include, but are not limited to, mechanically cutting, grinding, filing or rubbing the HTS tape to form one or more structural defects in an HTS tape. Abrasive processes or techniques may include, for example, using a mechanical technique such as filing with a file or other mechanical means. Such abrasive techniques are relatively simple and inexpensive compared with conventional chemical and laser etching approaches. Such mechanical means may include, but are not limited to a file, a cutter, a cutting tool, a grinder, a grinding tool, a saw, a knife, a scissors, a boring tool, or rubbing tool, a sanding tool and a laser.

Furthermore, it should be appreciated that although reference is sometimes made herein to certain configurations of HTS devices (e.g., configurations of HTS cables or configurations of HTS magnets or other HTS structures) or to certain types of HTS tape such as HTS tape comprising rare-earth barium copper oxide (REBCO), it should be understood that such references are not intended to be, and should not be, construed as limiting. Rather, such references to specific HTS device configurations and HTS materials are made solely to promote clarity in the description of the broad concepts related to control of distribution of electrical current within HTS devices such as HTS cables and/or an HTS magnets to provide such devices (and generally any HTS structures) having improved performance in a wide range of superconducting applications including but not limited to high-field magnets for compact fusion energy devices, portable medical imaging machines, and high-current power transmission.

At present, there is no known technique to substantially change the intrinsic current flow characteristics of an HTS cable or magnet. This is a problem because electrical current is often disproportionately concentrated in the outer layers of an HTS tape stack, which negatively impacts the performance of the HTS cable or magnet. To date, this has limited the feasibility of short HTS cables (10 cm or less) because the distance required for current flow to uniformly distribute itself among the tapes after entering an HTS cable is effectively fixed at approximately 10 cm. Artificial defects offer a method for precisely tuning the current distribution to improve the performance of an HTS cable by, for instance, improving current uniformity over shorter distances and at lower operating currents.

Chemical and laser etching have previously been used to induce artificial defects for other applications, but these etching techniques are cumbersome and costly.

The creation of defects by an abrasive or mechanical techniques, on the other hand, is relatively simple and inexpensive and has similar efficacy when compared with the complexity, expense and efficacy of chemical and laser etching techniques.

The characteristics of the defects required to produce the desired effect (the critical current of the tape at the defects and the location of the defects) are predicted by computational circuit model. To obtain a 50% reduction of critical current with 0.1 cm axial extent located 10 cm from the end of one of the tapes, two notches are then filed that each remove 25% of the tape cross section from both edges of the tape with a 0.1 cm-thick file to narrow a section of tape to 50% of the original width of the tape. See Appendix I for details.

HTS technology is a rapidly growing industry, with a range of applications, including high-field magnets for compact fusion energy devices and portable medical imaging machines, and high-current power transmission. Controlling current flow with defects opens new capabilities in the design of HTS cables and magnets, reducing their cost through more efficient utilization of HTS and enabling precise tuning of their performance. Defect-induced current control is of particular interest for small tape stacks in which minimizing the dimensions and maximizing the range of available operating conditions is particularly important. Another commercial application of this invention is to enable HTS producers to increase their effective manufacturing yield by finding a new use for intrinsically defective tape sections.

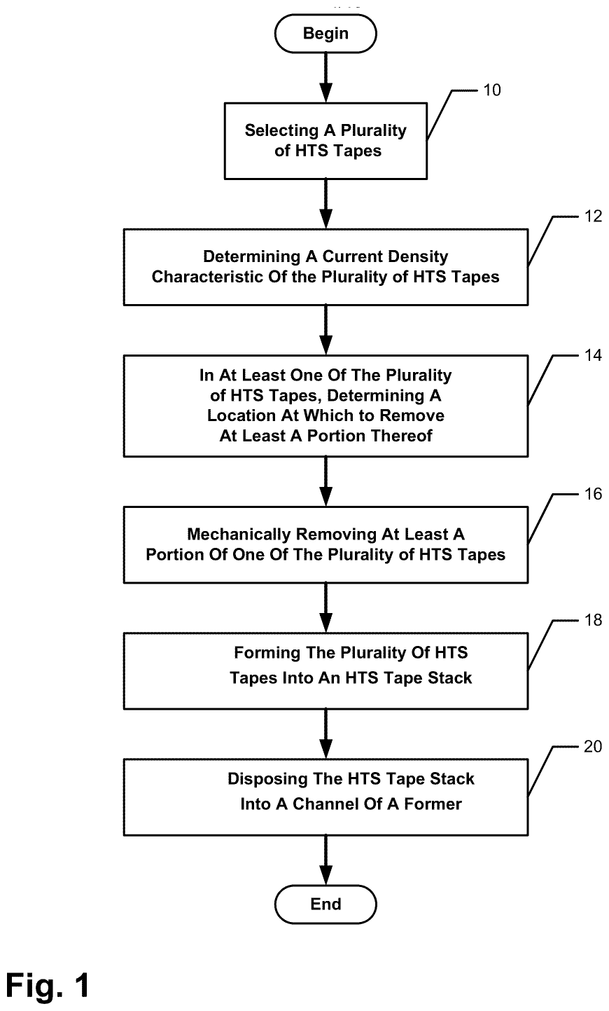

Referring now to FIG. 1, a process for making an HTS cable comprising an HTS tape stack begins by selecting a plurality of HTS tapes which will be stacked (or layered) to provide the HTS tape stack.

A current distribution characteristic of the one or more HTS tapes are determined using circuit modeling.

Based upon the determined current distribution characteristic, the positions (i.e. locations along a length of an HTS tape) at which one or more the defects are to be introduced into one or more HTS tapes are identified by iteratively computing the current distribution with a range of defect configurations until a defect configuration producing a desired current distribution is reached.

One or more mechanical defects are then introduced into one or more of the plurality of HTS tapes at positions along the tape as determined in the previous step. The size, shape and location of the one or more mechanical defects are selected to provide the HTS tape having a desired current distribution characteristic. In embodiments, at least one portion of the HTS tape is removed using mechanical or abrasive techniques to provide the HTS tape having the desired current density characteristic.

The plurality of HTS tapes (with at least one of such plurality of HTS tapes having at least one mechanical defect provided therein) are combined to form an HTS tape stack. It should be appreciated that any number of HTS tapes may be combined to provide the HTS tape stack.

The HTS tape stack comprising at least one HTS tape having a structural defect intentionally provided therein via a mechanical or abrasive technique is then disposed in a channel of a former. The former with the HTS tape stack having one or more structural defects may be used to form an HTS cable. It is understood that in embodiments, a former may have a plurality of channels and that each channel may have an HTS tape stack disposed therein with at least one of the HTS tapes stacks comprising an HTS tape having one or more structural defects intentionally provided there via mechanical and/or abrasive techniques.

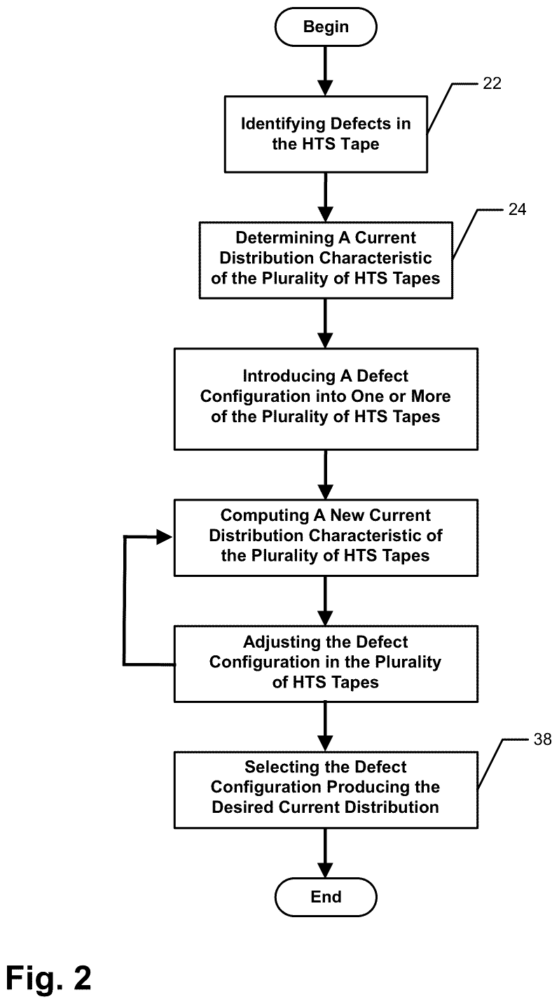

Referring now to FIG. 2, circuit modeling is used to select the defect configuration by computationally predicting the current distribution characteristic produced by a defect configuration, and iteratively adjusting the defect configuration and recalculating the current distribution characteristic until a desired current distribution characteristic is achieved.

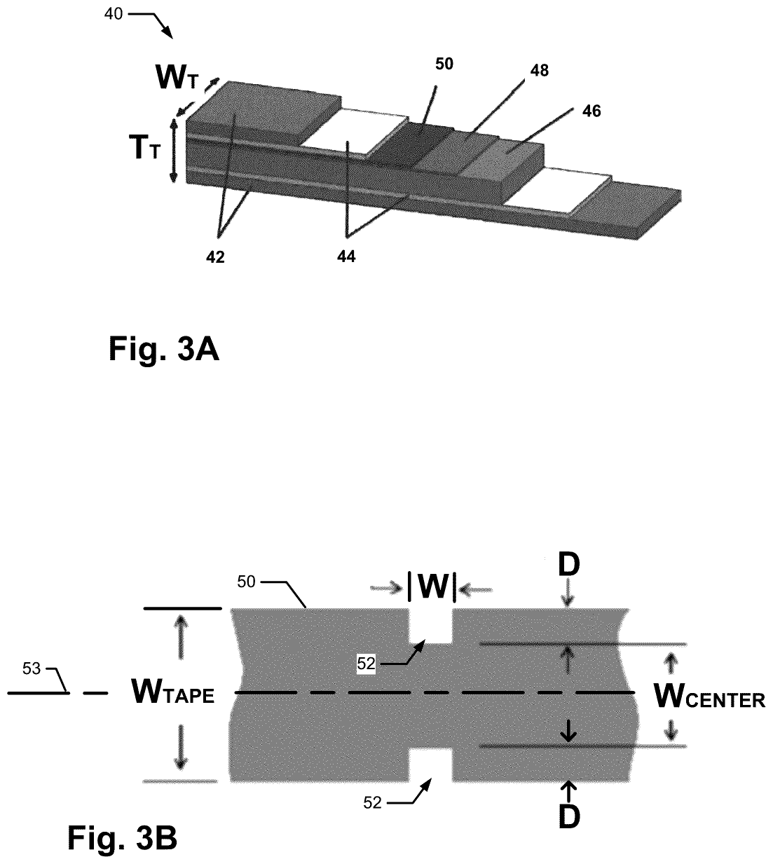

Referring now to FIG. 3A, as noted above, mechanical defects may be induced by abrasive removal of part of a cross section of one or more of the HTS tapes included in an HTS tape stack. In the example embodiment of FIG. 3A, several HTS tapes (e.g. more than two HTS tapes) are stacked, aligning the tapes so that their edges are flush with each other. The rigidity of the stack of tapes is higher than that of an individual tape, reducing tape bending during the filing procedure and therefore reducing the likelihood of damage to the REBCO layer outside of the notches; the stacking of the tapes has the secondary advantage of enabling defects to be induced in multiple tapes simultaneously, reducing total fabrication time. The tapes are secured together with thin strips of masking tape, and clamped on edge in a vise, ensuring that the tapes are level relative to the vise and table. A rectangular notch is filed into one edge of the tape stack partway across the width of the tapes, the stack is flipped over, and another notch is filed into the other edge of the stack symmetrically with the first. Care should be taken to ensure that the file remains level throughout the filing process. The stack is periodically unclamped, photographed with an optical microscope, and the notches measured digitally to determine when they had reached the desired size. (Alternatively, the tapes could be rested on appropriately sized shims to protrude over the top of the jaws of the vise by the desired size of the notches, filing the tapes until the file meets the top surface of the jaws.)

It is noted that when defects (e.g. notches having a substantially rectangular shape) are provided with a file or similar mechanical means, any off-level angle of the file may cause notches of maximum or minimum size to occur in the outermost HTS tapes of the HTS stack. Thus, critical currents of these defects are the bounds for the whole stack.

It should be recognized that since the outermost HTS tapes of the HTS tape stack experienced the most flexion and vibration during filing, some delamination may occur in the outermost HTS tapes of the HTS tape stack. However, these tapes may be discarded.

The performance of each batch of defects may be tested by measuring the critical currents of samples from the second-outermost pair of HTS tapes in the HTS tape stack, which may also subsequently be excluded from use in a fabricated HTS cable.

Critical currents of other defects in the stack can be estimated by interpolating between these bounds.

Tapes with the desired induced defect configuration may then be soldered into a channel of a former (e.g. a twisted or non-twisted former) to form an HTS cable with a solder or other molten metal filling the notch-shaped defect.

Referring now to FIG. 3A, an example of a REBCO HTS tape includes first and second stabilizer layers which may, for example, be provided as first and second copper layers. A first silver is disposed over the first stabilizer layer and a Hastelloy layer is disposed over the first silver layer. A buffer layer is disposed over the Hastelloy layer. A REBCO layer is disposed over the buffer layer and a second silver layer is disposed between the REBCO layer and the second stabilizer layer. Thus, the HTS tape is provided as a multi-layer structure.

Furthermore, it should be noted that although reference is made hereinabove to “a layer” some or all of the layers referred to above may comprise one or more layers. For example, some or all of the first and second stabilizer layers, first and second silver layers, the Hastelloy layer, the buffer layer and the REBCO layer may comprise one or more layers.

In this example embodiment, the HTS tape is provided having a width W_{T} in the range of about 2 mm to about 12 mm and a thickness T_{T} in the range of about 0.05 mm to about 0.1 mm. HTS tapes having other widths and thicknesses may, of course, also be used.

In embodiments the first and second stabilizer layers may, for example, be provided as first and second copper layers. A first silver is disposed over the first stabilizer layer and a Hastelloy layer is disposed over the first silver layer. A buffer layer is disposed over the Hastelloy layer. A REBCO layer is disposed over the buffer layer and a second silver layer is disposed between the REBCO layer and the second stabilizer layer. Thus, the HTS tape is provided as a multi-layer structure.

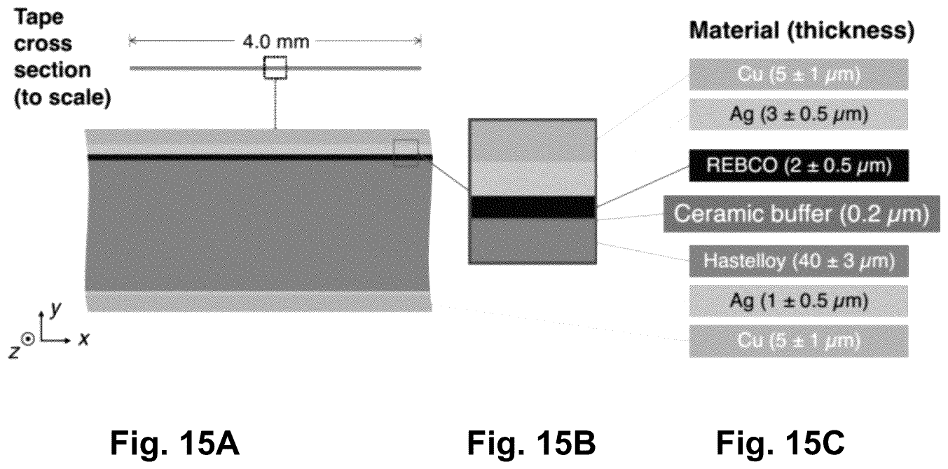

Referring now to FIG. 3B, an HTS tape 50 has selected portions thereof removed to provide the HTS tape having a pair of defects 52. In embodiments, the HTS tape may be provided as a REBCO tape which may be the same as or similar to the REBCO tapes described in conjunction with FIGS. 3A and 15C. In the example embodiment of FIG. 3B, portions of the HTS tape are removed (e.g. using a mechanical or abrasive process such as that described in conjunction with FIG. 3A) to provide defects 52 as a pair of rectangular-shaped notches on opposing sides of the HTS tape.

In this example embodiment, the HTS tape has a width W_{Tape} and each of the rectangular-shaped notch defects are provided having a width dimension W and a depth dimension D. Thus, in this example embodiment, the defects 52 (i.e. the selected portions removed from the HTS tape) are identically shaped. Furthermore, I this example embodiment, the selected portions (i.e., defects 50) are symmetrically arranged about the HTS tape. In this example embodiment the defects are symmetrically arranged about a centerline 53 of the HTS tape.

It should, of course, be appreciated that in other embodiments, it may be desirable or even necessary that defects 52 have shapes and/or dimensions of different sizes (e.g. in the case of the rectangular-shaped notch defects, the defects may be provided having different width and depth dimensions W and D). Also, the defects 50 need not be symmetrically disposed about the HTS tape. After reading the disclosure provided herein, one of ordinary skill in the art will appreciate how to select the shape, dimensions (size), and placement of defects in an HTS tape to achieve a desired current characteristic in the HTS tape.

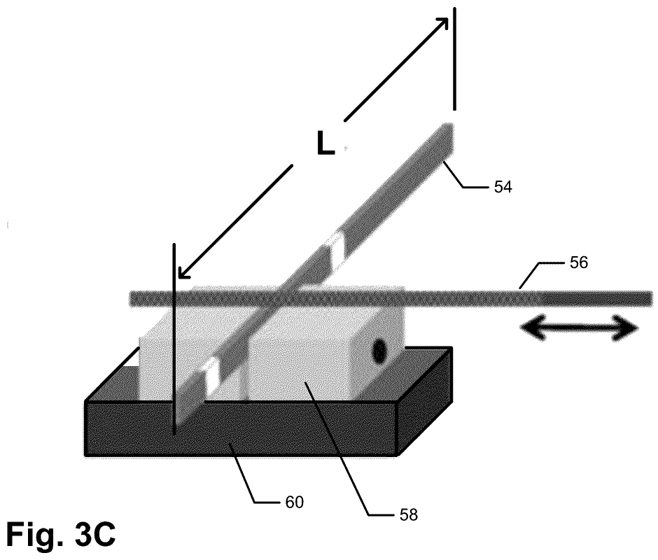

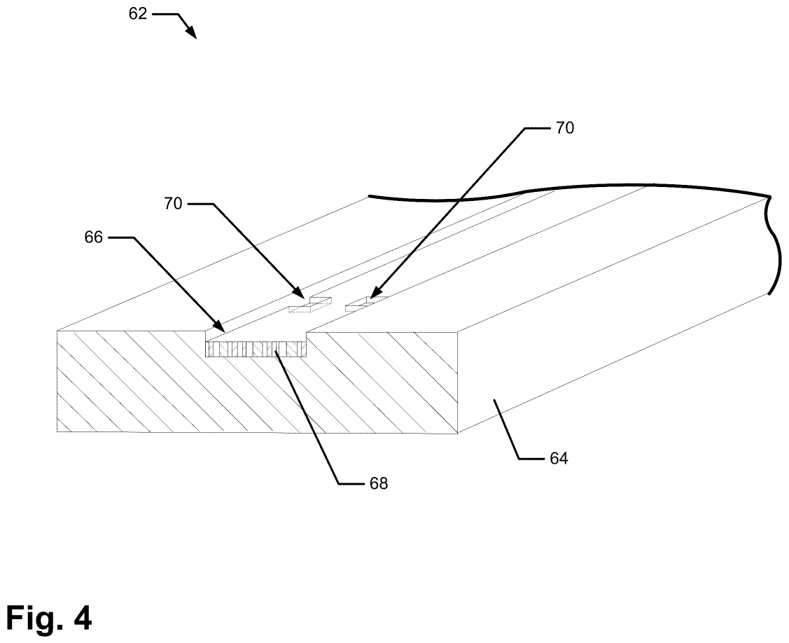

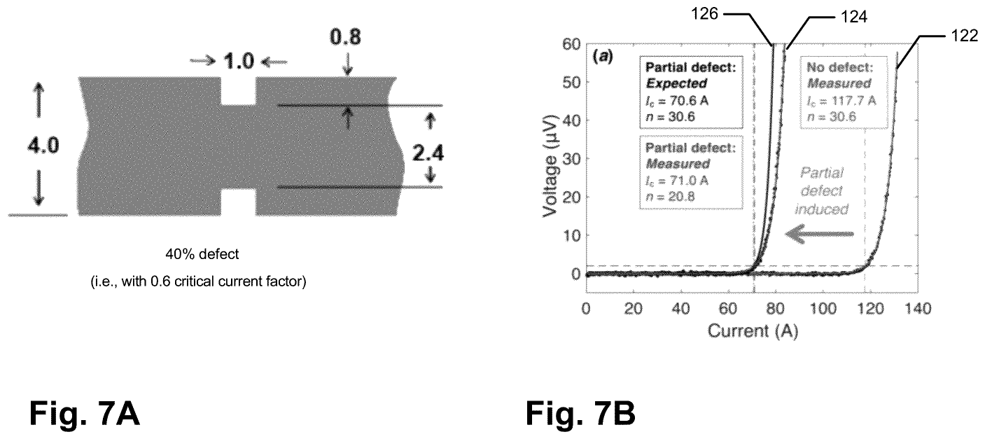

For example, to induce a 40% defect (that is, an HTS tape region with a 40% reduction in critical current I_{c} to a value of 0.6 I_{c} of the HTS tape) in a REBCO tape having a width of 4 mm (i.e., W_{TAPE}=4 mm), a rectangular-shaped notch defect extending 20% across the tape width (i.e. D=0.8 mm) is filed into each edge, creating a narrowed section with a width 60% of the full width of the tape (i.e. W_{CENTER}=2.4 mm) as shown in FIG. 3A and also FIG. 7A (FIG. 4.2).

It should be understood that although the example embodiment of FIG. 3A includes two defects, an HTS tape may be provided having one or more defects (e.g. one or more rectangular-shaped notch defects). One particular manner of mechanically or abrasively removing selected portions of an HTS tape (i.e., inducing a defect into an HTS tape) will be described in conjunction with FIG. 3C.

Referring now to FIG. 3C, a technique for forming a defect in one or more HTS tapes (i.e., a technique for removing selected portions of one or more HTS tapes such as HTS tape 50 in FIG. 3B) includes filing rectangular notches into one or more HTS tapes (e.g. REBCO HTS tapes) with a file or other mechanical tool 56.

The width of the file is selected such that the file can be used to provide a defect having a desired width. For example, to provide a defect having a width of 4 mm, a file or other tool having a width of 4 mm may be used. For example, a file having a width in the range of about 0.5 mm to about 4 mm (for example, a width of 1.0 mm) may be used. Files or other mechanical tools having other widths may also be used. The particular width of a file or other mechanical tool used to provide defects in one or more HTS tapes for a particular application will depend upon the needs of the particular application. For example, in cases in which it is desirable to provide one or more rectangular-shaped notch defects having a width of less than 1 mm (for example a width of 0.5 mm), then a file having a width of less than 1 mm (for example, a width of 0.5 mm) may be used. Similarly, in cases in which it is desirable to provide a circular shaped defect, a file having a circular cross-section may be used.

The filing technique illustrated in FIG. 3C removes material from all layers of the HTS tape.

For example, when the HTS tape is provided as REBCO tape (e.g. as shown in FIG. 3A), the filing technique illustrated in FIG. 3B removes material from all layers of the HTS REBCO tape.

This is in contrast to conventional chemical and laser bridging techniques, in which only the REBCO, copper, and silver layers on one side of the tape are removed, leaving the remaining portions of the cross section of the HTS tape intact.

In the example of FIG. 3C, the positions (i.e. locations along the length L of the HTS tape) at which the defects are to be introduced are marked or otherwise identified on the HTS tapes.

In one example embodiment, a plurality of HTS tapes (e.g., eight to twelve REBCO tapes) which may be the same as or similar to the REBCO tape described above in conjunction with FIG. 3A, are stacked while aligning the HTS tapes such that their edges are substantially flush with each other to form an HTS tape stack 54.

The rigidity of the HTS tape stack 54 is higher than that of an individual tape, thereby reducing tape bending during the procedure to provide defects (e.g. a filing procedure) and thereby reducing the likelihood of damage to one or more REBCO layer(s) outside of the defects. The stacking of the HTS tapes has the secondary advantage of enabling defects to be concurrently induced in multiple HTS tapes, thereby reducing total fabrication time.

The HTS tapes may be secured together using any appropriate technique to form the tape stack. For example, any appropriate fastening technique may be used such as with an adhesive fastener (e.g. strips of tape as illustrated in FIG. 3B) or with a mechanical fastener or by soldering or otherwise joining together the HTS tapes. The secured group of tapes are held together while ensuring the tapes are in a position such that a file can be used to provide defects therein.

For example, in the embodiment of FIG. 3C, the HTS tape stack 54 is made level relative to the holding mechanism (e.g. vise 58) and platform 60 (e.g. table or workbench or manufacturing area) on which the holding mechanism is disposed.

One or more defects having a substantially rectangular shape (e.g. as shown in FIG. 3A) may be filed into one edge of the HTS tape stack partway across the width of the tapes. The HTS stack of secured tapes is then flipped over, and one or more defects having a rectangular shape are filed into the other edge of the HTS tape stack. In embodiments, the defects are provided symmetrically into each side of the secured HTS tapes. In embodiments, the defects may be provided in both sides of an HTS tape or an HTS tape stack substantially simultaneously.

When using a file to provide one or more defects, care should be taken to ensure the file remains level throughout the filing process. The HTS tape or HTS tape stack may periodically be inspected to determine when a desired defect size and shape has been achieved. For example, the HTS tape or HTS tape stack may be unclamped, photographed with an optical microscope, and the notches measured digitally to determine when a desired defect size and shape has been achieved.

Alternatively, HTS tapes could be placed or otherwise disposed on appropriately sized shims protruding over the top of the jaws of the vise 56 (or other holding mechanism) by the desired size of the notches, filing the tapes until the file meets the top surface of the jaws.

It is noted that any off-level angle of the file may cause notches of maximum or minimum size to occur in the outermost tapes of the stack. Thus, critical currents of these defects are the bounds for the whole stack of HTS tapes.

During a mechanical process such as filing, some delamination may occur in some or even all HTS tapes. For example, in the filing technique of FIG. 3C, the outermost HTS tapes in the HTS tape stack 54 may experience the most flexion and vibration during filing. Thus, some delamination may occur in such outermost HTS tapes. In this case such delaminated HTS tapes may be discarded.

The performance of each batch of HTS tapes having defects may be tested by measuring critical currents of samples of HTS tape from an HTS tape stack. In embodiments, the second-outermost pair of HTS tapes in the HTS stack may be used. Such HTS tape samples tested by measuring critical currents, may also subsequently be excluded from use in fabrication of an HTS cable. In the case where critical currents of samples of HTS tape from an HTS tape stack are measured using the second-outermost pair of HTS tapes in the HTS stack, critical currents of other defects in the HTS tape stack can be estimated by interpolating between these bounds.

Referring now to FIG. 4, a portion of an HTS cable 62 comprises a conductor 64 (e.g., a former) having a channel 66 provided therein. To promote clarity in the drawings and accompanying text, in the example embodiment of FIG. 4, the former is illustrated as a non-twisted former having a single channel provided therein. It should, of course, be appreciated that in other embodiments, the former may be provided as a twisted former having a plurality of channels provided therein. In embodiments, the former may be provided from copper. Other conductive materials may, of course, also be used. The former may be used to form an HTS cable.

An HTS tape stack 68 is disposed in the channel 66. The HTS tape stack comprises a plurality of layers of HTS tapes with at least one of the HTS tapes having at least one mechanical defect provided therein. In an HTS cable or magnet or other structure, the active superconducting component is the layer of HTS tape (or a plurality of layers of HTS tapes) stacked and soldered together with other HTS tapes which form the HTS tape stack.

In the example embodiment of FIG. 4, the HTS tape stack has a pair of mechanical defects 70 provided therein. As illustrated in FIG. 4, the mechanical defects continue through each layer of HTS tape in the HTS tape stack. Thus, each layer of HTS tape has substantially the same mechanical defect provided therein.

In this example embodiment, the defects in the HTS tape stack are provided as notches having a rectangular shape.

It should be appreciated that mechanical defects may be provided having shapes other than a rectangular shape. For example, the mechanical defects may be provided having any regular geometric shape including but not limited to a square shape, a rectangular shape, a triangular shape, a hexagonal shape, a heptagonal shape, an octagonal shape, any multi-sided shape, an elliptical shape or a circular shape. Irregular shapes may also be used.

It should, however, be appreciated that in practical systems, mechanical defects 70 may be provided at different locations along a length of an HTS tape stack comprising a plurality of HTS tapes or mechanical defects may be provided in certain ones of HTS tapes (e.g. certain individual HTS tapes within an HTS tape stack) at different locations along a length of the individual HTS tapes.

HTS tapes having a desired mechanical defect configuration may thus be stacked and soldered into one or more channels of the former (e.g., a twisted or non-twisted copper former) to form a cable with solder or other molten metal filling the defects (e.g. notches 70 may be filled with solder or other molten metal).

HTS tapes with a desired induced partial mechanical defect configuration locally reduces the current carrying capacity (“critical current”) of an HTS tape, causing current to be driven into adjacent tapes (e.g., adjacent HTS tapes within an HTS tape stack). By strategically providing or introducing defects in one or more selected layers of an HTS tape stack—and by controlling the size, shape and density of defects—the current distribution across the stack of HTS tapes is shaped to provide an HTS cable or magnet having a desired performance.

Thus, the example embodiment of FIG. 4 illustrates a high-temperature superconducting (HTS) cable comprising a plurality of HTS tapes each having a width, a thickness, a first surface and a second opposing surface. The plurality of HTS tapes are arranged to provide an HTS tape stack 68 with at least one of the plurality HTS tapes in the HTS tape stack having one or more selected portions 70 thereof removed. The locations of the one or more selected portions removed 70 in the at least one of the plurality HTS tapes are selected to provide the HTS tape stack having a selected current carrying capacity characteristic. Preferably, locations of each of the one or more selected portions removed from the at least one of the plurality HTS tapes are selected such that a current carrying capacity of the at least one of the plurality HTS tapes is reduced compared with a current carrying capacity of an HTS tape having no portions thereof removed. In the example HTS cable 62 embodiment of FIG. 4, each of the at least one of the plurality HTS tapes in the HTS tape stack 68 has a selected cross-section thereof removed (i.e. a selected portion 70 thereof removed). It is appreciated that in other embodiments, fewer than all of the HTS tapes in the HTS tapes stack (for example, one HTS tape in the HTS tape stack) may have one or more selected cross-sections thereof removed. Preferably, locations of each of the at least one of the plurality HTS tapes having all or a portion of a selected cross-section thereof removed are selected to reduce the current carrying capacity of the HTS tape compared with a current carrying capacity of an HTS tape having no portions thereof removed. In embodiments, one or more of the HTS tapes in the HTS tape stack may have all or a portion of a cross-section thereof removed to reduce the current carrying capacity of the at least one of the plurality HTS tapes. In embodiments, selected portions of a cross-section of each of the at least one of the plurality HTS tapes is removed to reduce the current carrying capacity of each of the at least one HTS tape. The locations of the selected portion (i.e., the location of introduced mechanical defects) in each HTS tape may the same or different in each HTS tape (i.e. the mechanical defects may be provided in each HTS tape at different locations such that the mechanical defects in each tape do not align when the tapes are arranged to form an HTS tape stack). In the example HTS cable embodiment of FIG. 4, each of the plurality of HTS tapes are arranged such that each of the plurality of HTS tapes has at least one of the first and second surfaces contacting at least one of the first and second surfaces of another HTS tape in the HTS tape stack.

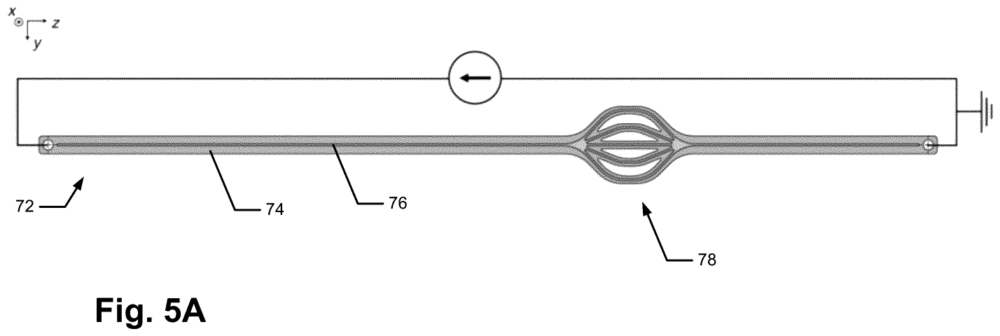

Described in conjunction with FIGS. 5A-5C is an HTS cable and corresponding circuit model to predict and interpret behavior of an HTS cable 72 and to provide predictive capabilities scalable to larger cables.

While circuit modeling approaches have previously been used to investigate aspects of REBCO cable and magnet behavior, such prior circuit modeling approaches do not provide high physical fidelity or spatial resolution, a shortcoming overcome by the circuit model described herein.

Referring now to FIG. 5A, HTS cable 72 includes a non-twisted copper former 74 having disposed in a channel thereof a plurality or stack of REBCO HTS tapes 76. One or more of the HTS tapes 76 are provided having a desired mechanical defect. In embodiments, one or more HTS tapes having desired mechanical defect configurations are stacked and soldered into the non-twisted copper former to form HTS cable 72. In embodiments, a layer of solder (or other molten metal) is disposed above the HTS tape stack with the solder filling the defects. In this example embodiment the HTS tape stack 76 comprises five HTS tapes 76a-76e which are separated in a separation region 78 of HTS cable 72.

A measurement circuit 80 may be used to measure critical current in the individual HTS tapes 76a-76e of the HTS tape stack 76. Thus, the structure of FIG. 5A may be used to validate a circuit model shown in FIG. 5B.

Referring now to FIG. 5B, shown is a schematic diagram of a middle plane of a circuit model of the HTS cable of FIG. 5A. To represent intentionally introduced defects, the critical current of the superconductive variable resistors in the axial region of the REBCO tape containing the defect is multiplied by the geometric critical current factor of the defect (e.g., 0.6 for a 40% defect) and the power law exponent is multiplied by 0.7 which is an approximate factor. The approximate factor may also be found experimentally, as described herein at least in conjunction with FIGS. 7A, 78 below. The highest allowed resistance for a partial defect resistor is that of a full-width defect composed entirely of conductive solder.

Referring now to FIGS. 5B and 5C, the three-dimensional structure of the HTS cable of FIG. 5A is represented with a lumped-element circuit model comprising three stacked circuit planes.

FIG. 5C is an enlarged view of a node portion of the schematic of FIG. 5B which illustrates that relative to the middle plane, the upper and lower planes are stacked out of and into the page (i.e. along the x-axis of FIG. 5B), respectively, and are coupled to the middle plane via resistors shown in yellow in FIG. 5B.

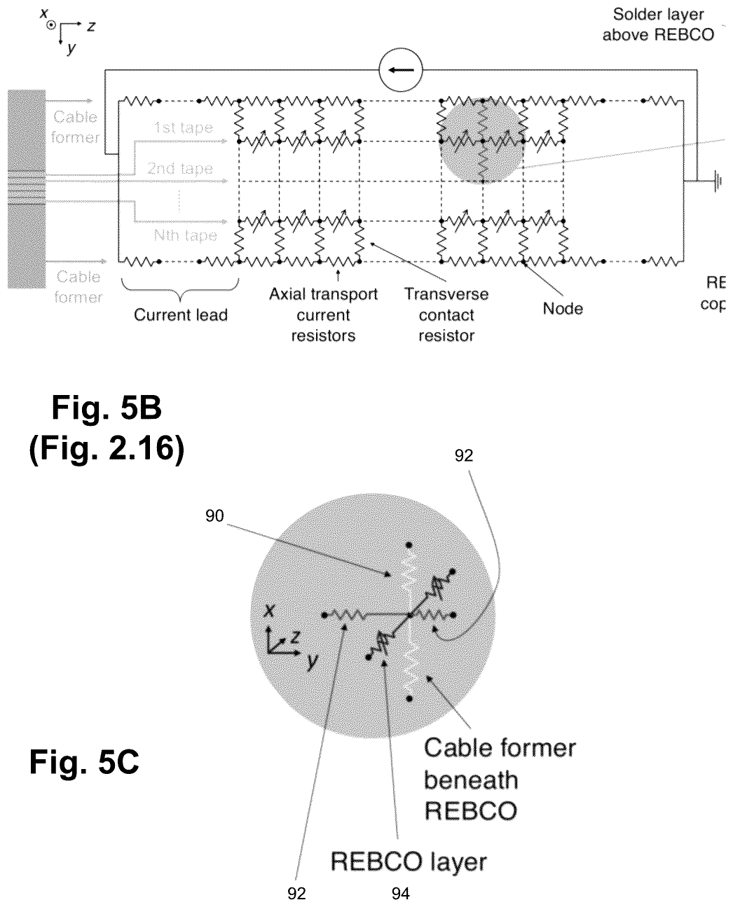

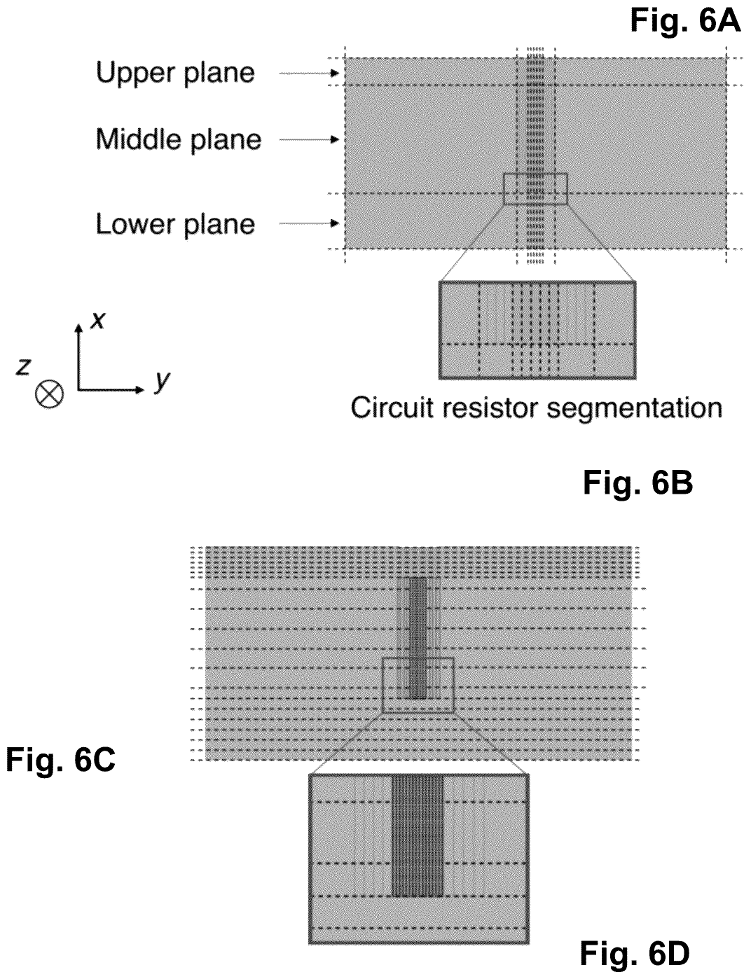

Referring now to FIGS. 6A-6D schematic cross section of the cable, showing how the cable is segmented into circuit resistors and Biot-Savart current filaments.

As shown in FIG. 6A, the middle plane contains REBCO tapes and most of the former (e.g. a copper former). The upper plane contains a solder (e.g., a PbSn solder) or other molten metal and former segments lying above the tapes. The lower plane contains the former segments lying beneath the tapes.

The z-axis of the model is aligned with the long axis of the cable, and the y-axis is normal to the face of the REBCO tapes. The middle plane is connected at the nodes to the upper and lower planes by x-oriented resistors 90 lying in the plane of the tapes and orthogonal to the long axis of the cable shown in FIG. 5C.

In the middle plane, the former is represented by a series of axial z-oriented fixed resistors; the REBCO layer of each REBCO tape is represented by a series of axial z-oriented variable resistors 94 (two of which are shown in FIG. 5C). The transverse y-oriented resistors 92 (two of which are shown in FIG. 5C) represent the transverse contact resistance between the axial z-oriented layers due to the non-REBCO layers of the REBCO tapes, the solder matrix around the tapes, and the copper dummy tapes inserted between the outer tapes and the former. REBCO tapes are asymmetrical, with a ‘thin side’ containing copper and silver layers, and a ‘thick side’ containing Hastelloy, copper, and silver layers. The resistance of the transverse y-oriented resistors therefore depends on the relative orientation of the REBCO tapes. For example, a transverse y-oriented resistor representing two adjacent thick sides has a significantly higher resistance than a resistor representing two adjacent thin sides.

The ceramic buffer layer between the REBCO and Hastelloy layers of the REBCO tape is neglected for simplicity.

The effect of including the buffer layer on modeled cable behavior is discussed below [in conjunction with FIGS. 15-17E].

### Computation

The independent variables that determine the electrical behavior of the circuit are the resistances of its resistors and the operating current delivered to the cable by the power supply. The dependent variables that describe the circuit's behavior are the nodal voltages of the circuit, which are computed with nodal analysis [70], a method that solves Kirchhoff's circuit laws in the form of matrix operations. The vector of nodal voltages Vis given by:

$$V = {[ {V}_{k} ]}_{N \times 1} = {G}^{- 1} l , \qquad ( 2.6 )$$

### Where:

Vₖ is the voltage at node k,
N is the total number of nodes,
G is the nodal admittance matrix
I is the vector of current sources.

The elements of G are:

$$G = {[ {g}_{kj} ]}_{N x N} \qquad ( 2.7 )$$

where diagonal element gₖₖ is the sum of the reciprocals of the resistances of all resistors connected to node k and off-diagonal element gₖⱼ is minus the reciprocal of the resistance of the resistor connected between nodes k and j. In this circuit, G is symmetric and sparse. The procedures for calculating the resistances in G are described hereinbelow.

The elements of I are:

$$I = {[ {l}_{k} ]}_{N \times 1} = [ \begin{matrix}{l}_{op} \\ 0 \\ ⋮ \\ 0\end{matrix} ] \qquad Eq . ( 2.8 )$$

where element Iₖ is the sum of all current sources flowing into node k and lop is the operating current of the cable delivered by the power supply.

The computed current I_{comp} flowing in each resistor is found with Ohm's law:

$${l}_{c o m p} = Δ V / R , \qquad ( 2.9 )$$

where
ΔV is the nodal potential difference across the resistor; and
R is the resistance.

### 2.3.3 Calculation of Fixed Conductive Resistances

The z-direction resistance R_{z} of an axial z-oriented fixed resistor is given by:

$${R}_{z} = ρ {l}_{\underline{z}} / {l}_{x} {l}_{y} \qquad ( 2.1 )$$

where
ρ is the resistivity at 77.4 K of the material of which the resistor is composed;
   I_{z} is the length of the resistor in the axial z-direction;
Iₓ is the length of the resistor in the tape-plane x-direction; and
I_{y} is the length of the resistor in the transverse y-direction.

The values of these and other parameters used in the model are shown in the Table below which shows circuit model parameters and REBCO tape specifications.

TABLE

| Parameter | Symbol | Value | |
|---|---|---|---|
| Resistivity of C101 Cu | ρ | 0.1956 | μΩ-cm |
| (RRR~100) at 77.4 K | | | |
| Resistivity of Ag at 77.4 K | ρ | 0.2694 | μΩ-cm |
| Resistivity of Pb₃₇Sn₆₃ at 77.4 K | ρ | 3.6 | μΩ-cm |
| Resistivity of Hastelloy at 77.4 K | ρ | 124.0 | μΩ-cm |
| Length of x-oriented tape-plane | lₓ | 0.1 | cm |
| resistors in upper plane | | | |
| Length of x-oriented tape-plane | lₓ | 0.4 | cm |
| resistors in middle plane | | | |
| Length of x-oriented tape-plane | lₓ | 0.2 | cm |
| resistors in lower plane | | | |
| Length of x-oriented tape-plane resistors | lₓ | 0.1 | cm |
| between middle and lower planes | | | |
| Length of x-oriented tape-plane resistors | lₓ | 5 × 10⁻² | cm |
| between middle and upper planes | | | |
| Length of y-oriented transverse | l_{y} | 0.625 | cm |
| resistors in former | | | |
| Length of y-oriented transverse | l_{y} | 2 | μm |
| resistors in defect | | | |
| Thickness of Cu dummy tape | l_{y} | 114 | μm |
| Thickness of Cu layer on REBCO | l_{y} | 5 | μm |
| ‘thin side’ | | | |
| Thickness of Ag layer on REBCO | l_{y} | 3 | μm |
| ‘thin side’ | | | |
| Thickness of Hastelloy layer on | l_{y} | 40 | μm |
| REBCO ‘thick side’ | | | |
| Thickness of Ag layer on REBCO | l_{y} | 1 | μm |
| ‘thick side’ | | | |
| Thickness of Cu layer on REBCO | l_{y} | 5 | μm |
| ‘thick side’ | | | |
| Thickness of PbSn layer between tapes | l_{y} | 23.5 | μm |
| Length of z-oriented axial resistors | l_{z} | 0.1 | cm |
| located > 0.2 cm from a defect | | | |
| Length of z-oriented axial resistors | l_{z} | 0.025 | cm |
| located ≤ 0.2 cm from a defect | | | |

The y-direction resistance R_{y} of a transverse y-oriented fixed resistor is given by:

$${R}_{y} = \frac{1}{{l}_{x} {l}_{z}} {\sum }_{i} {ρ}_{i} {l}_{yi} \qquad Eq 2.11$$

where Iₓ is the same as in Equation 2.10, I_{z} is the z-distance between the middle points of the two axial z-oriented resistors on each side of the nodes to which the transverse y-oriented resistor connects, ρᵢ is the resistivity at 77.4 K of a component i of the resistor, and I_{yi} is the length of resistor component i in the transverse y-direction.

The x-direction resistance Rx of a tape-plane x-oriented fixed resistor is given by:

$${R}_{x} = ρ {l}_{x} / {l}_{y} {l}_{z} \qquad ( Eq . \_ 2.12 )$$

where
ρ is the resistivity at 77.4 K of the resistor,
Iₓ is the length of the resistor in the tape-plane x-direction,
Iy is the same as in Equation 2.10, and
I_{z} is the mean of the values for the two axial z-oriented resistors on each side of the nodes to which the tape-plane x-oriented resistor connects.

The defects that are complete gaps in HTS tapes (e.g. REBCO tapes) are referred to herein as “full-width gaps” or “full-width defects.” For example, when all HTS material has been removed from an entire cross section of an HTS tape, the HTS tape is said to have a full-width defect. Such full-width defects become filled with solder during a soldering process and are represented by conductive resistors with the properties of solder in the model.

### Calculation of Variable REBCO Resistances

The resistances of the z-oriented axial REBCO variable resistors are not known a priori because of the interdependence of REBCO resistance, current, and nodal voltages. After assigning all conductive resistances elsewhere in the circuit, REBCO resistances are found so that the current in each REBCO resistor that is consistent with nodal analysis (Equation 2.9) equals the current that is consistent with the constitutive REBCO power law. Expressing the power law in inverted form, with current as a function of voltage, the current in each REBCO variable resistor is given by:

$${I}_{REBCO} = {I}_{c} ( B ) {( \frac{Δ V}{{V}_{c}} )}^{\frac{1}{n}} , \qquad ( Eq . 2.13 )$$

where I_{c}(B) is the critical current of the resistor at 77.4 K (whose dependence on magnetic field B is discussed in Section 2.3.5), ΔV is the nodal potential difference across the resistor computed by nodal analysis (Eq. 2.6), and V_{c} is the critical voltage corresponding to the 1 μV/cm electric field criterion. The no-defect tapes are all assumed to have an initial critical current in all REBCO resistors of 115.7 A at 77.4 K, self-field, based on mean measurements of several sacrificial tape samples, but in principle an arbitrary spatial distribution of critical current could be used in which each resistor has its own critical current, based for instance on reel-to-reel critical current measurements of the very tapes used in an experimental cable.

After initializing the REBCO resistances (using a value of 10% of the resistance of a typical axial copper former resistor) and computing the nodal voltages of the whole circuit, the REBCO resistances R_{REBCO} are iteratively adjusted with the following substitution:

$${R}_{{REBCO}_{i + 1} =} {R}_{{REBCO}_{i}} \frac{{I}_{c o m p}}{{I}_{REBCO}} , \qquad ( Eq . 2.14 )$$

### Where

I is an index which represents an analysis iteration;
R_{REBCOi+1} is the value of R_{REBCO} at nodal analysis iteration i;
I_{comp} is the current from Eq. 2.9; and
I_{REBCO} is the current from Eq. 2.13.

To understand the effect of Equation 2.14, consider two scenarios: I_{comp}<I_{REBCO} implies that the REBCO resistor's presently assigned resistance is too high, leading to a value of I_{comp} computed by nodal analysis that is lower than is consistent with the superconductive nature of the resistor, so Equation 2.14 reduces the resistance by a factor of the ratio of the discrepant currents; conversely, I_{comp}>I_{REBCO} implies that the resistance is too low, so Equation 2.14 increases the resistance. The model recomputes the nodal voltages V throughout the circuit with Eq. 2.6, reevaluates the currents I_{comp} and I_{REBCO} in all REBCO resistors with Eqs. 2.9 and 2.13, and readjusts the resistance RREBCO in all REBCO resistors with Equation 2.14. The process is repeated until all nodal voltages have converged to a tolerance of 0.01%; at this point all voltages, currents, and resistances in the entire circuit are mutually consistent.

The novel approach described herein was developed because it is better suited to modeling the electrodynamics of this 3D system.

And this approach is in contrast to the conventional parallel path method found in the literature, which gives only 1 D estimates of superconductive-conductive current sharing as described in K. Kuroda. Current sharing in a fully stabilized superconductor. J. Appl. Phys., 46:3160-3166, 1975; J. van Nugteren et al. Powering of an HTS dipole insert-magnet operated standalone in helium gas between 5 and 85 K. Supercond. Sci. Technol., 31:065002, 2018; and N. Riva et al. Development of the first non-planar REBCO stellarator coil using VIPER cable. Supercond. Sci. Technol., 36(10):105001, 2023.

A one-tape, no-defect cable was modeled to test this method for a simple case and the results of the model showed good agreement with the 1D parallel path method on the current sharing ratio between superconductive and conductive components of the cable as a function of operating current.

The inventors have also recognized that the efficiency and speed of the method described herein could be increased by incorporating nonlinear equation solvers and analytically computing the Jacobian, which would reduce the number of iterative computations required in the existing model.

### Magnetic Fields and Critical Current Corrections

REBCO critical current is a function of the incident magnetic field; self-generated magnetic fields in the cable must therefore be taken into account. To do this, the cable is sliced into several y-z planes, dividing each resistor into several filaments, as shown in FIG. 2.17. The current flowing in a conductive resistor is distributed uniformly in all its filaments.

The current flowing in a REBCO variable resistor is distributed by successively filling the filaments up to their individual critical currents, starting with the outer filaments and proceeding toward the center; additional current above the total critical current of the resistor is distributed uniformly in its filaments.

Computing the magnetic field in every REBCO filament due to the currents in every other filament in the whole circuit is computationally expensive. To reduce the computational expense, the magnetic field in every REBCO filament can be approximated by applying the infinite wire Biot-Savart result to every other filament in the same x-y plane. The total x- and y-components of magnetic field Bₓᵣ and B_{yr} acting on each REBCO filament r located at (xᵣ, yᵣ) due to the z-oriented currents Iₗ flowing in every other filament l located at (xl, yl) in the same x-y plane of the cable is given by:

$$\begin{matrix}{B}_{xr} = \frac{{μ}_{0}}{2 π} {\sum }_{l} {l}_{l} \frac{yr - yl}{{( xr - xl )}^{2} + {( yr - yl )}^{2}} \\ {B}_{yr} = - \frac{{μ}_{0}}{2 π} {\sum }_{l} {l}_{l} \frac{xr - xl}{{( xr - xl )}^{2} + {( yr - yl )}^{2}} ,\end{matrix} \qquad ( Eq . 2.15 )$$

where
μ₀ is the magnetic permeability of free space.

From this the magnitude B and direction θ of the magnetic field may be calculated as:

$$\begin{matrix}B = \vert B \vert = \sqrt{{{B}_{xr}}^{2} + {{B}_{yr}}^{2}} \\ θ = \vert arctan \frac{{B}_{xr}}{{B}_{yr}} \vert .\end{matrix} \qquad ( Eq . 2.16 )$$

The magnetic field incident on a filament due to another filament is proportional to the current in the other filament and inversely proportional to the distance from the other filament. At the closest spacing, the centers of REBCO filaments in neighboring tapes may be as little as 20 μm apart in the case where HTS tapes are stacked with thin sides facing each other. If the number of filaments into which the REBCO variable resistors are divided is too low (that is, if the filaments are insufficiently fine), the nearest pair of filaments will dominate the magnetic field calculation and produce an unphysically high magnetic field. The number of filaments into which each REBCO variable resistor is divided should be sufficiently high that the distance between filaments in the same tape is less than or equal to the smallest distance between filaments in adjacent tapes (in this case, 200 filaments). The number of filaments into which the conductive resistors need to be divided is much lower because the currents flowing in these resistors are significantly smaller and the distances from the REBCO filaments are significantly larger; the conductive resistors were therefore divided into only 10 filaments.

The critical current of each REBCO filament is calculated by interpolating measured I_{c}(B) data, obtained with an HTS-110 SuperCurrent 12 T machine for a REBCO tape sample from the reel used in the experiments, with critical current scaled to the mean 77.4 K self-field value of 115.7 A obtained from measurements of several other REBCO tape samples in the same reel. The critical current of each REBCO variable resistor is found by summing the critical currents of its constituent filaments.

The above describes computation of the critical current that is used and also describe computation of the current distribution that is used. The computations iterate back and forth until all nodal voltages and critical currents have converged to tolerances of 0.01% and 0.1%, respectively.

Referring now to FIG. 7A, an HTS tape includes a pair of partial defects (mechanically-induced intentional partial defects) in a defect-seeded Tape B configuration cable in which all defects are 1.0 cm in axial length. In embodiments the HST tape in Fib 7A may be provided as a REBCO tape.

FIG. 7B shows: (1) measured characteristics of a REBCO tape with no defect; (2) measured characteristics of a REBCO tape with a 40% defect; and (3) predicted characteristics (using the model describe herein) of a REBCO tape with a 40% defect. As shown in FIG. 7B, a comparison of the characteristics may be made by plotting voltage as a function of measured current for the REBCO tape with no defect (curve 122), the measured current of the REBCO tape with a 40% defect (curve 124) and the expected current of the REBCO tape with a 40% defect (curve 126) as predicted by the model, described herein. Dashed lines indicate critical currents and voltages.

Typical voltage-current curves for a mechanically-induced intentional partial defect compared to a tape with no defect are shown in FIG. 7B. The critical current of the no-defect tape sample was 117.7 A (at 77.4 K, self-field), with a power law exponent of 30.6. After introducing a 40% defect into the tape (by filing notches that removed 20% of the tape cross section from each edge of the tape), the critical current was expected to be reduced by 40% to 70.6 A, with the same power law exponent of 30.6; the measured critical current was found to be 71.0 A (within 0.57% of the expected value), but with a reduced power law exponent of 20.8 (a factor of approximately 0.68 of the power law exponent for the no-defect tape, which is similar to the observed change in power law exponent caused by other bridging techniques [62]). Generally, critical currents could be consistently tuned using mechanically-induced partial defects to within 2% of the desired value.

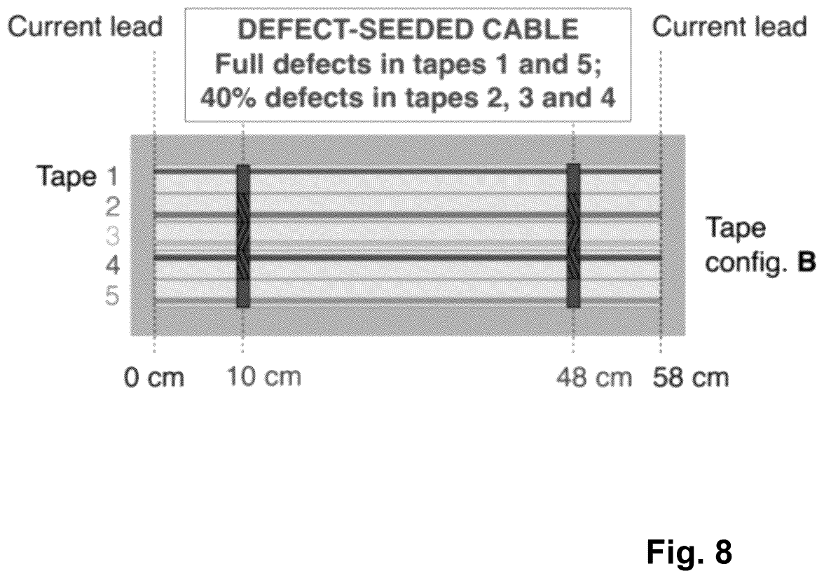

FIG. 8 shows a defect configuration in a defect-seeded configuration B cable where all defects are 0.1 cm in axial length.

### Defect Configuration and Tape Configuration

Several different induced partial defect configurations were modeled with the circuit model to find by hand a configuration that significantly improves current uniformity through the full range of operating currents. It should be noted that an algorithm could be used to test a much larger number of cases to find an optimal configuration for use with a particular application. To reduce the parameter space of possible defect configurations and to ease cable fabrication, four defect characteristics were constrained:
(i) the total number of defects was limited to one symmetrical pair of defects per tape, which was the minimum number required to individually control of current flow in each tape while maintaining axially symmetrical electrical behavior;
(ii) the number of distinct axial defect positions was limited, aligning all defects at a pair of symmetrical axial positions near the ends of the cable;
(iii) an effort was made to minimize the required precision of partial defect fractions (for example, favoring a 40% defect over a 39.5% defect); and
(iv) an effort was made to reduce the total number of distinct partial defect fractions present in the cable (for example, favoring a configuration containing three 40% defects over a configuration containing two 40% defects and a 35% defect).

The chosen defect configuration that fulfills these guidelines, which was implemented with REBCO tape configuration B, is shown in FIG. 8 and described by the following: (a) a pair of full defects in tape 1, one defect located 10 cm axially from the current lead joint at one end of the cable and the other 10 cm from the joint at the other end of the cable (or 48 cm from the first joint, as the total length of the cable is 58 cm, excluding the region where the tapes splay from each other for current distribution measurements); (b) the same defect configuration in tape 5 as in tape 1; (c) a pair of 40% defects in tape 2, one defect located 10 cm from the joint at one end of the cable, the other 10 cm from the joint at the other end; (d) The same defect configuration in tapes 3 and 4 as in tape 2.

The HTS cable of FIG. 8 is referred to herein as the ‘defect-seeded’ configuration B cable.

### Defect-Improved Current Uniformity

The defect configuration was chosen to demonstrate the use of defects to improve current uniformity. To aid discussion and interpretation of the results, ‘current uniformity’ is defined as:

$$Current uniformity = 1 - R M S R \qquad ( Eq . 4.1 )$$

where RMSR is the root mean squared residual, given by:

$$R M S R = \sqrt{\frac{1}{N} {\sum }_{i} {( {f}_{i} - \frac{1}{N} )}^{2}} , \qquad ( Eq . 4.2 )$$

where N is the number of HTS tapes and fᵢ is the current fraction in each tape i.

Current uniformity in a five-tape cable ranges between a minimum of 0.6, signifying the lowest possible uniformity where all operating current is segregated in one tape in the stack, and a maximum of 1, signifying ideal uniformity where operating current is equally split between all five tapes. The lower bound of current uniformity is a function of the number of tapes.

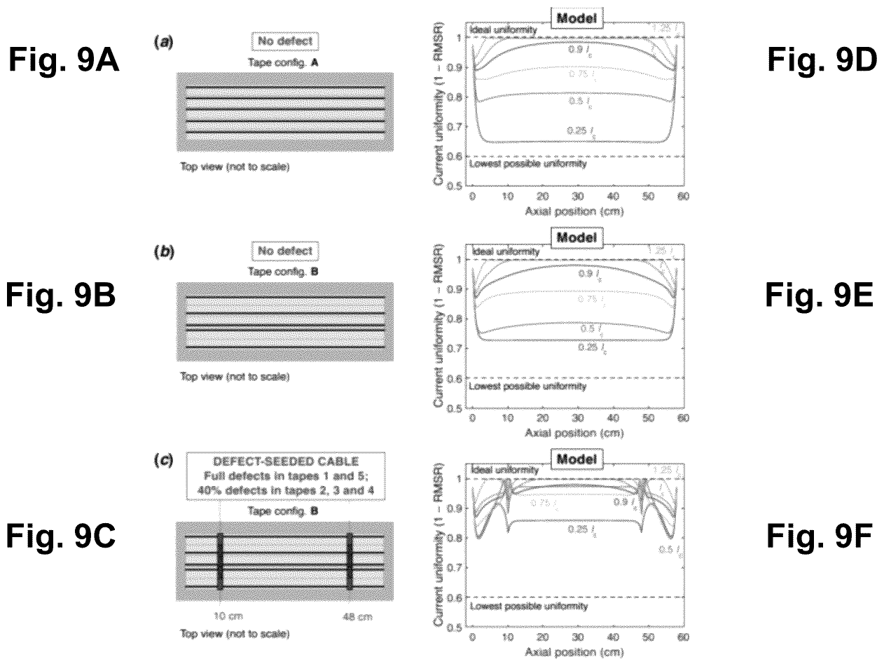

As shown in Eq. 1 above, current uniformity is defined as 1-RMSR and is a function of axial position at various operating currents predicted by the model for three HTS cables. HTS tape orientations for these configurations are shown schematically in FIGS. 9A-9C.

FIGS. 9A-9C illustrate the three HTS cables while FIGS. 9D-9F show results for each configuration with FIG. 9D showing results for the no-defect configuration A HTS cable illustrated in FIG. 9A; FIG. 9D showing results for the no-defect configuration B HTS cable in FIG. 9B; and FIG. 9E showing results for the defect-seeded configuration B HTS cable of FIG. 9C.

The improvement to current uniformity caused by changing the tape configuration and introducing carefully arranged induced defects is evident by comparing FIGS. 9D-9F.

Thus, FIGS. 9A-9E illustrate model-predicted current uniformity as a function of axial position at various operating currents, comparing the defect-seeded cable with no-defect configuration A and B cables.

As expected, current uniformity is axially symmetrical because of the symmetrical geometry of the cables and symmetrical defect configuration. Near the current leads (located at 0 cm and 58 cm), current uniformity is similar in all cables. After current entry regions of approximately 5 cm from each current lead, the current distributions are fully developed and the current uniformity falls to a spatially-slowly-varying value throughout the length of the cable between the current entry regions. In each cable, current uniformity increases throughout the full cable length with increasing operating current, reaching unity throughout most of the cable length at the critical current of the cable. At overcritical currents, current uniformity increases to unity over an increasing proportion of the cable length.

In the no-defect configuration A cable, as current is segregated within tape 1 at low operating currents below the critical current of tape 1, the current uniformity in most of the length of the cable is near the lowest possible value (about 0.65 at 0.25 I_{c} of the cable, compared with the minimum value of 0.6). In the no-defect configuration B cable, as current divides equally into tape 1 and 5 at low operating currents below the combined critical current of tapes 1 and 5, the current uniformity is higher than that of the no-defect configuration A cable (0.73 at 0.25 I_{c}), though the no-defect configuration A cable's current uniformity increases more rapidly as operating current is increased (increasing to 0.81 at 0.5 I_{c} and 0.90 at 0.75 I_{c}, compared with 0.79 and 0.89, respectively, for the no-defect configuration B cable). This confirms a previous expectation: the model predicts that current uniformity can be improved by changing the tape configuration of a cable.

In the defect-seeded configuration B cable, current uniformity is similar to the no-defect cables in a ˜2 cm region at each end of the cable, but is significantly higher than in both the no-defect configurations A and B cables along the remainder of the cable length. Moving away from the current leads, current uniformity increases rapidly spatially as the defect locations are approached, dips slightly in sharp troughs in the immediate vicinity of the defects, and is significantly higher than the no-defect cables in the region between the defect locations. As a function of operating current, current uniformity along most of the length of the cable begins much higher than in the no-defect cables at low operating currents (0.86 at 0.25 I_{c}), increases rapidly at operating currents above about 0.25 I_{c}, and remains above 0.95 for operating currents of 0.5 I_{c}, while a current uniformity of 0.95 is only reached in the no-defect cables at operating currents of 0.8 I_{c}. Thus, the model predicts that defects can be used to improve current uniformity over the full range of operating currents and in a large proportion of the length of a cable, especially in the region between the defect locations. The model also predicts that current uniformity can be significantly improved in almost the full length of a cable by only inducing defects in spatially concentrated regions near the ends of the cable, leaving most of the lengths of the tapes unmodified, a useful result for ease of implementation in cable fabrication. The significant improvements in current uniformity at low and intermediate operating currents makes defect seeding a particularly promising tool for optimizing current distribution in devices with operating currents in these ranges, such as superconducting fault current limiters [52]. In the next subsection is a discussion of experimental validation of the use of defects for improving current uniformity.

### Experimental Validation of Defect-Improved Current Distribution

To validate the concept of the use of defects as a tool for improving current uniformity, current distribution was measured at one axial position in the cable, located 40 cm along the cable's length. The model predicts a very weakly-spatially-varying current uniformity in the region between the defects (see FIGS. 9D-9F), which are aligned at 10 cm and 48 cm, so these current distribution measurements at 40 cm provide insight into current uniformity that is representative of the entire region between the defects.

Three cables with the same defect configuration were fabricated to assess the repeatability of the results; the cables exhibited similar experimental behavior.

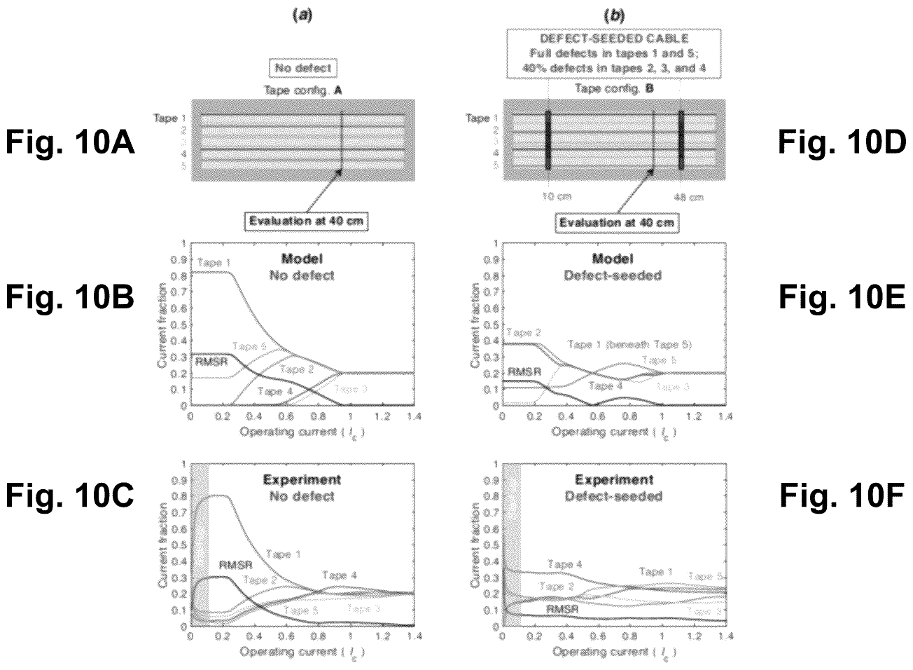

Referring now to FIGS. 10A-10F, a comparison of current distribution as a function of operating current in a no-defect configuration A cable (FIG. 10A) and a defect-seeded configuration B cable (FIG. 10D) is shown. FIGS. 10B, 10C, 10E, 10F show a comparison of model predictions and experimental measurements. The shaded portions (≲0.1 I_{c}) of the experiment plots (FIGS. 10C, 10F) indicate non-physical ‘start-up’ effects, possibly associated with the startup of the power supply.

FIGS. 10A-10F illustrate the current fraction distributed in each tape as a function of operating current in one of these cables, evaluated at a 40 cm axial position. Current distribution in the defect-seeded configuration B cable is compared with that in the no-defect configuration A cable to show the defect- and tape-configuration-induced change in current distribution compared to a conventional cable. As can be seen from FIGS. 10B, 10C and 10E, 10F model predictions and experimental measurements are in general agreement that the defect-seeded configuration B cable has a much lower RMSR than the no-defect configuration A cable at low operating currents, signifying improved current uniformity. While the precise current fraction distributed to each individual tape is not as accurately predicted by the model as other characteristics, the general trend of current fraction in each tape as a function of operating current is well-predicted, except for the current fraction in tapes 2 and 3, where current appears to have been transferred from tape 2 to tape 3 at low operating currents relative to the model prediction. The improvement in current uniformity in the defect-seeded configuration B cable compared with the no-defect configuration A cable is in fact greater in the experiment than in the model; RMSR in the defect-seeded configuration B cable is ≲0.07 across the full range of operating currents, measuring 0.07 at near-zero operating currents (compared with the predicted 0.15, and the predicted and measured 0.3 for the no-defect configuration A cable), falling gradually with increasing operating current to 0.05 at the critical current of the cable, and falling to 0.03 at 1.4 I_{c}. RMSR never converges completely to zero, suggesting a longer current redistribution length in the experiment than predicted by the model. Overall, the experimental results validate the concept of using a model-guided configuration of induced partial defects to improve current uniformity in REBCO cables.

### Defect-Induced Power Dissipation

The benefits of defects as tools for controlling current distribution have been shown. However, this is accomplished at the cost of additional defect-induced power dissipation. The cable can be stably operated without quenching if the total power dissipation and local power dissipation density do not exceed the cryogenic cooling capacity. Though power dissipation was not directly measured experimentally, the model enables power dissipation to be predicted at a given operating current and location in the cable by calculating the product of the nodal potential difference across and the current through the corresponding resistors

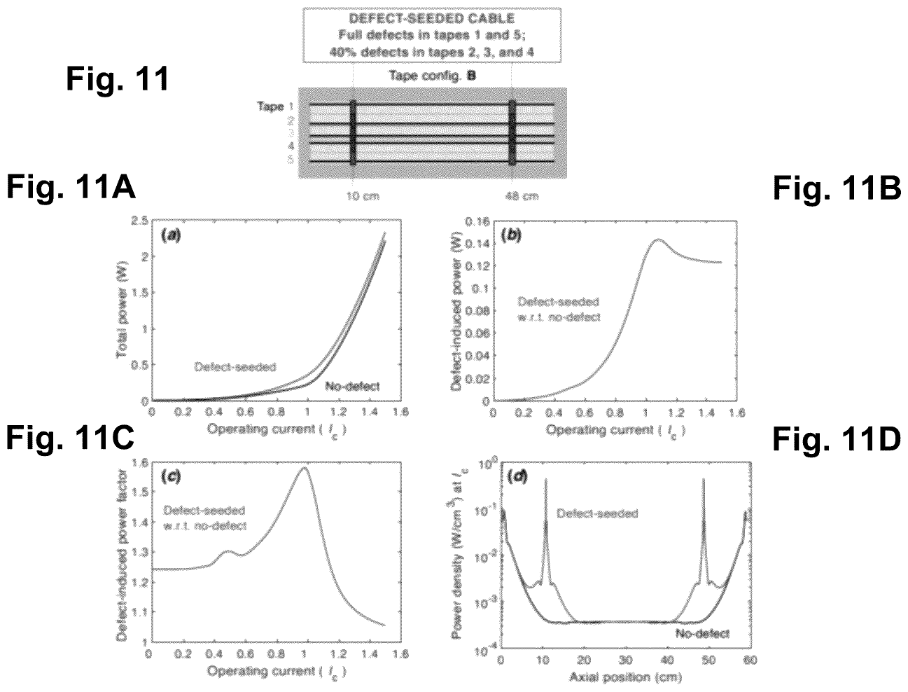

FIGS. 11-11D are a series of plots which illustrate defect-induced power dissipation in the defect-seeded configuration B cable of FIG. 11 compared with no-defect configuration B cable. In FIG. 11A shown is total power dissipation as a function of operating current. In FIG. 11B shown is total defect-induced power dissipation as a function of operating current. FIG. 11C shows total defect-induced power dissipation factor with respect to no-defect cable as a function of operating current. FIG. 11D shows volumetric power dissipation density at the critical current of the cable as a function of axial position.

FIGS. 11-11D thus show various representations of defect-induced power dissipation in the defect-seeded configuration B cable compared with the no-defect configuration B cable. Total power dissipation at a given operating current is found in the model by summing the power dissipation of all resistors in the circuit. As noted above, FIG. 11A shows total power dissipation as a function of operating current, comparing the defect-seeded cable with the no-defect cable.

As noted above, FIG. 11B shows the total power dissipation induced by the defects as a function of operating current, found by subtracting the power dissipation of the no-defect cable from that of the defect-seeded cable. Defect-induced power grows exponentially as a function of operating current up to the critical current of the cable, with a slight increase of exponent at ˜0.6 I_{c} of the cable. Defect-induced power is less than 0.02 W at operating currents ≲0.6 I_{c}; at operating currents above this threshold, defect-induced power increases more rapidly, reaching a maximum of 0.14 W at 1.08 I_{c} (on top of a baseline total power dissipation of ˜0.23 W in the no-defect cable), and asymptotes to approximately 0.12 W for overcritical operating currents.

FIG. 11C shows the defect-induced total power dissipation factor for the defect-seeded configuration B cable with respect to the no-defect cables as a function of operating current (that is, the ratio of total power dissipated by the defect-seeded cable to total power dissipated by the no-defect cable). The defect-induced power factor is a useful quantity for predicting by what factor total cooling must be increased to maintain the cable's thermal stability at given operating currents. This factor is approximately constant with respect to the no-defect cable at operating currents up to about 0.5 I_{c} (with a value of approximately 1.25), before increasing rapidly as a function of operating current in the current range 0.5 I_{c}<Iop<I_{c}; a maximum value of 1.58 is reached at I_{c}; the factor then decreases rapidly as a function of operating current at overcritical currents.

Volumetric power dissipation density as a function of axial position is calculated in the model for transversely-divided segments of the cable, with each segment comprising a group of parallel axial resistors with the same axial coordinate and the half of all transverse resistors on the boundary of the segment that lies within the segment; the volume of the segment is equal to product of the length of the axial resistors (typically 0.25 mm or 1.0 mm), the width of the cable (14.0 mm), and depth of the cable (7.0 mm); the volumetric power dissipation density of the segment is given by the sum of the power dissipation of all resistors in the segment divided by the volume of the segment.

FIG. 11D shows volumetric power dissipation density as a function of axial position, evaluated at the critical current of the cable (because this is the operating current with the maximum defect-induced power dissipation factor), and plotted on a logarithmic vertical axis to show the shape of the distribution more clearly. Sharp peaks centered on the defects are induced, with maximum values of 0.44 W/cm³; far from the defect-induced peaks, power density is similar to that of the no-defect cable. The sharpness and magnitude of the peaks are exacerbated by the alignment of defects at the same axial positions; the peak power densities could be reduced by spreading the defects over a longer axial region.

The total dissipated powers and power densities predicted so far are likely manageable with appropriate cooling system design in small cables similar to those studied in this work, but further study is needed with the circuit model and dynamic quench models of power dissipation and thermal stability in larger-scale cables. While this work has focused on a defect configuration that optimizes for current uniformity, the model could also be used to find a defect configuration that optimizes the dissipated power density profile or minimizes total power dissipation, perhaps coupling the model to an optimization algorithm to automate the process; this could enable the design of highly defect-tolerant cables. This work should be extended to study power dissipation and thermal stability with defects in cables operating in the 20 K to 40 K range typical of real-world applications, where heat removal is more challenging than with the 77.4 K liquid nitrogen immersion-cooled operating conditions used so far.

### Scaling the Model to a Larger Cable

It is noted the HTS cables and results describes above have been limited in scale to five REBCO tapes for reasons of computational and experimental practicality.

It should, however, be appreciated that the concept of defect seeding to improve current distribution as described herein applies to HTS cables and any structures, devices, components including any number of HTS tapes. For example, a model may be scaled by an order of magnitude to a cable containing 50 HTS tapes (sometimes referred to herein as a ‘50-tape defect-seeded’ cable).

This scaled model allows exploration of the applicability of the concepts and techniques described herein to cables closer to practical real-world scale.

It is appreciated that computational time significantly increases with an increased number of HTS tapes (e.g. ˜10 CPU-hours per operating current step in the 50-tape cable, compared with 3-5 CPU-minutes per operating current step in the five-tape cable, approximately scaling with the square of the number of tapes).

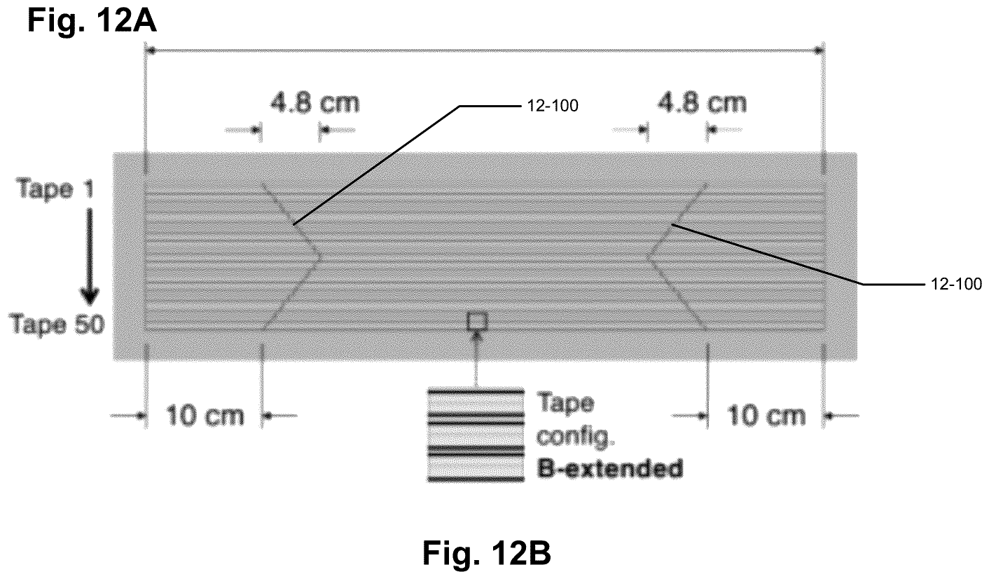

FIG. 12A is a schematic diagram of defect configurations in a 50-tape defect-seeded cable with tape configuration B-extended. FIG. 12B is an enlarged view of a portion of the HTS cable of FIG. 12A. Defects are indicated with reference numerals 12-100; all defects are 0.1 cm in axial length and are configured in chevron arrangements as described below. The defect configuration and tape configuration in the 50-tape defect-seeded cable are thus shown schematically in FIGS. 12A, 12B.

The HTS tapes in the HTS cable of FIG. 12 are arranged in a symmetrical, alternating pattern, with the REBCO layer in the outermost pair of tapes (1 and 50) facing toward the cable former, the next outermost pair (2 and 49) facing inward, the pair immediately within that (3 and 48) facing outward, and so on throughout the stack. This configuration is referred to as tape configuration ‘B-extended’ because the pattern is akin to a scaled-up version of tape configuration B.

The defects, each measuring 0.1 cm in axial length, are configured as follows: (a) the defects are physically arranged in a symmetrical pair of chevrons, with the defects in the outermost pair of tapes (1 and 50) located 10 cm axially from each end of the tape stack, the defects in the innermost pair of tapes (25 and 26) located 14.8 cm from each end of the tape stack, and defects in other tapes interpolated linearly between these bounds such that the axial distance between the centers of adjacent defects is 0.2 cm (except the defects in tapes 25 and 26, which are at the same axial position); and (b) the defects in the outermost pair of tapes (1 and 50) are full defects, the defects in the innermost pair of tapes (25 and 26) are non-defects (that is, they are 0% partial defects having no effect on the critical currents of their tapes), and the defects in other tapes are partial defects with extent interpolated linearly between these bounds.

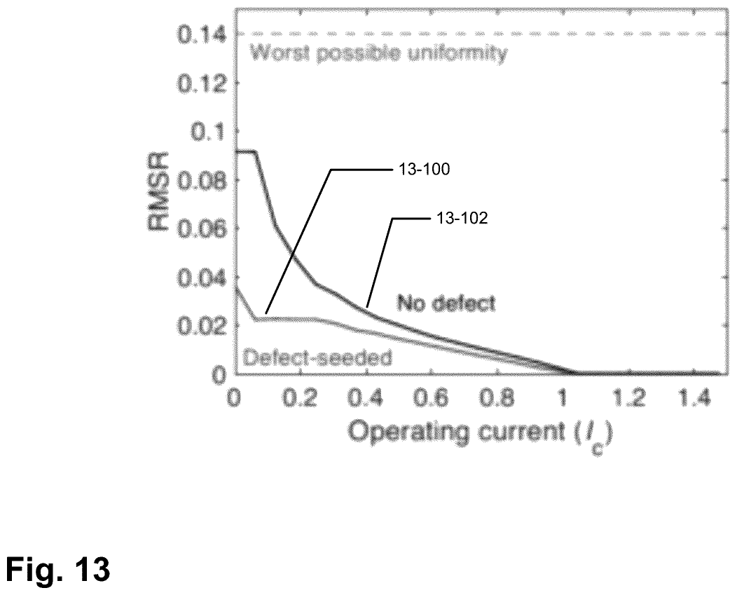

FIG. 13 illustrates current distribution RMSR as a function of operating current with curve 13-100 corresponding to the defect seeded HTS cable and curve 13-102 corresponding to the no-defect HTS cable. A comparison of no-defect and defect-seeded 50-tape configuration B-extended HTS cables (i.e. a comparison of curves 13-100 and 13-102), shows significant improvement in current uniformity in the defect-seeded 50-tape configuration B-extended HTS cables.

The critical current of the cable predicted by the model was 2.627 kA at 77.4 K, self-field. The model was run for 21 operating current time steps, spanning the operating range from 0 to 1.5 I_{c} of the cable for a 50-tape no-defect configuration B-extended cable and a 50-tape defect-seeded configuration B-extended cable. The full set of computations for each cable required ˜10 CPU-days to complete. The RMSR for each of these cables is compared in FIG. 4.8, which shows the significant decrease in RMSR across the full range of operating currents induced by the defect-seeding of the cable. This represents a significant improvement in current uniformity, demonstrating the ability to use defect seeding to favorably modify the current distribution in REBCO cables of practical real-world scale.

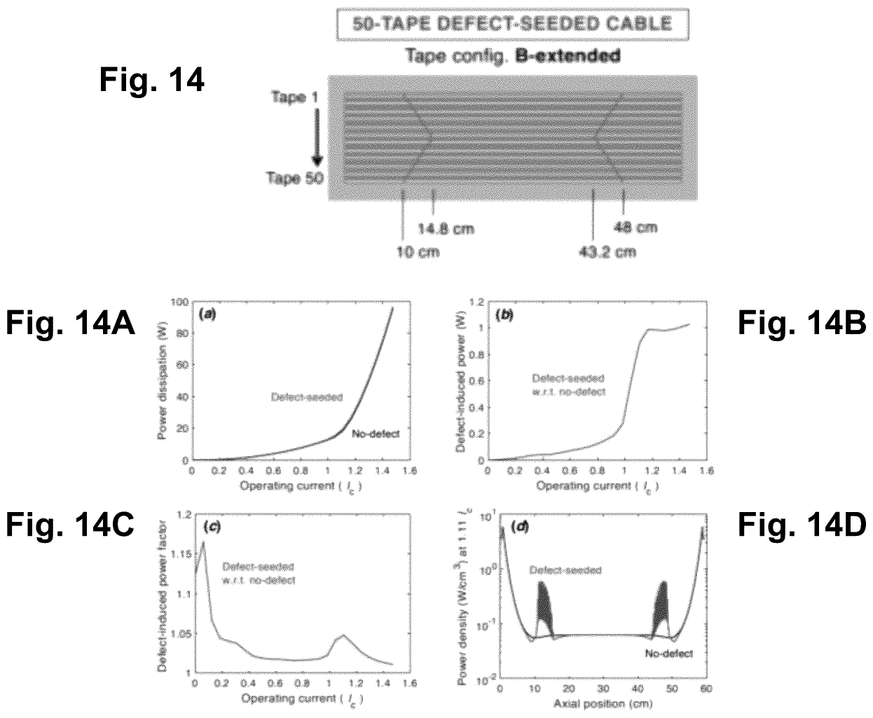

Referring now to FIGS. 14-14D, defect-induced power dissipation in the 50-tape defect-seeded configuration B-extended cable (FIG. 12), compared with no-defect configuration B-extended cable. FIG. 1A shows total power dissipation as a function of operating current. FIG. 14B shows total defect-induced power dissipation as a function of operating current. FIG. 14C shows total defect-induced power dissipation factor with respect to no-defect cable as a function of operating current. FIG. 14D shows volumetric power dissipation density at 1.11 I_{c} of the cable as a function of axial position.

Thus, various representations of defect-induced power dissipation in the 50-tape defect-seeded configuration B-extended cable compared with the 50-tape no-defect configuration B-extended cable are shown in FIGS. 14A-14D. A comparison of the total power dissipation as a function of operating current in the defect-seeded and no-defect cables is shown in FIG. 14A and defect-induced power as a function of operating current is shown in FIG. 14B. Defect-induced power increases approximately exponentially as a function of operating current up to the critical current of the cable (reaching 0.28 W at I_{c}, on top of a baseline no-defect power dissipation of 12.9 W), increases significantly more rapidly in the overcritical range I_{c}<Iₒₚ≲1.15 I_{c}, and remains at approximately 1.0 W for lop≳1.15I_{c}.

FIG. 14C shows the defect-induced power dissipation factor as a function of operating current in the defect-seeded cable with respect to the no-defect cable. The defect-induced power dissipation factor is highest at very low operating currents, before falling rapidly and remaining approximately constant for most of the intermediate and high operating current range; the average value of the defect-induced power dissipation factor is approximately 1.019 for 0.35I_{c}<Iₒₚ<I_{c}, indicating only a 1.9% increase in required overall cooling power to maintain thermal stability, significantly less than the five-tape defect-seeded cable (FIG. 14C). At overcritical operating currents, the defect-induced power dissipation factor increases to a maximum of 1.048 at 1.11 I_{c}, falling again at higher operating currents.

FIG. 14D shows the volumetric power dissipation density as a function of axial position, evaluated at 1.11 I_{c} of the cable (the operating current with the maximum defect-induced power dissipation factor), comparing the 50-tape defect-seeded and no-defect cables. Far from the axial regions of the cable containing defects, power dissipation density is similar in both cables. Within the defect regions, closely-spaced peaks of power dissipation density axially aligned with the defects emerge, with a maximum value of 0.59 W/cm³, similar in magnitude to that calculated in the five-tape cable despite the significantly higher absolute operating current, because of the spreading of the defects over a longer axial region. This, along with the significantly lower defect-induced power dissipation factor in the 50-tape defect-seeded cable than in the five-tape defect-seeded cable, suggests that from the perspective of cooling system design and likely thermal stability, defect seeding scales up favorably to larger cables.

Next described in conjunction with FIGS. 15A-17E are the effects of including the buffer layer on modeled cable behavior.

FIG. 15A is cross sectional view of an HTS cable while FIG. 15B is an enlarged view of a portion of an HTS layer included in the HTS cable of FIG. 15A and FIG. 15C is an enlarged portion of the HTS layer illustrated in FIG. 15B.

In a REBCO tape, a ceramic buffer layer between the REBCO and Hastelloy layers acts as a diffusion barrier preventing the contamination of the REBCO by the Hastelloy and provides a biaxial textured surface that promotes optimal REBCO crystal structure. The buffer layer consists of several stacked oxide layers, including LaMnO3, MgO, Y2O3, and Al₂O₃, with a total thickness of ˜0.2 μm. The buffer layer is shown schematically in FIG. 15C. In the circuit model, the buffer layer was neglected for simplicity. The inventors recognize, however, the omission of the high resistivity of the buffer layer may explain at least some of the discrepancy between the predicted and measured current distribution at intermediate operating currents.

To assess this possibility, the model was run with a buffer layer inserted between the REBCO and Hastelloy layers. It is difficult to measure or obtain reliable data on the appropriate buffer resistivity to use in the model; instead, the model was run for several different buffer layer resistivities and the resistivity that produced a voltage-current curve similar to the experiment was selected.

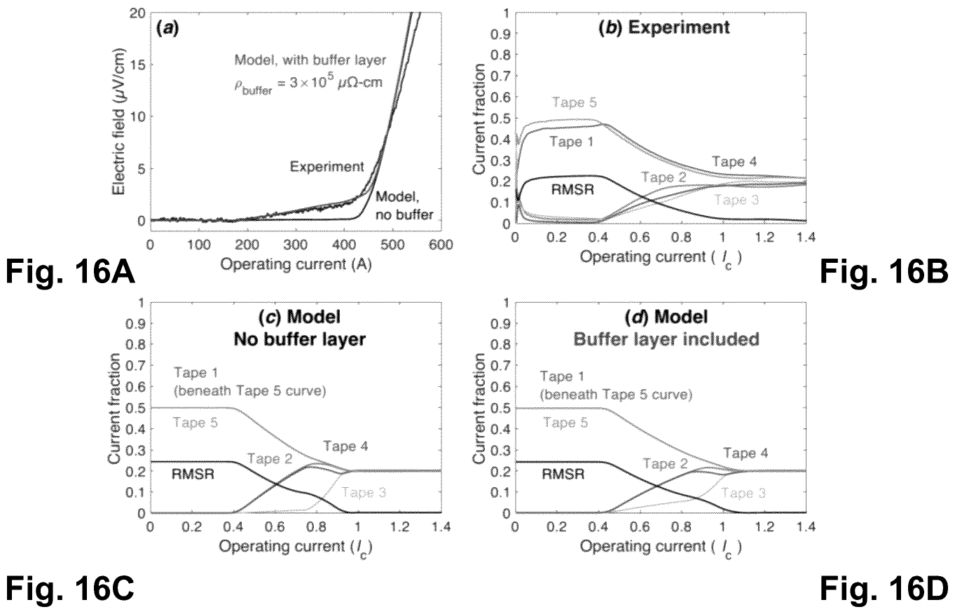

As shown in FIG. 16A, which compares modeled and experimental electric field at the axial midpoint as a function of operating current for a no-defect configuration B cable, this occurred with a buffer resistivity of 3×10⁵ μΩ-cm.

FIGS. 16A-16D are a series of plots illustrating effects of a REBCO tape buffer layer on predicted no-defect configuration B cable behavior.

FIG. 16A shows Comparison of electric field at the axial midpoint of the cable as a function of operating current for the experiment, and for the model with and without a buffer layer.

FIGS. 16B, 16C, 16D show current fraction as a function of operating current for the experiment (FIG. 16B), the model without the buffer layer (FIG. 16C), and the model with the buffer layer (FIG. 16D).

FIG. 16D shows the modeled current distribution as a function of operating current for a no-defect configuration B cable with REBCO tapes including a buffer layer with this resistivity; comparison with the modeled current distribution that omits the buffer layer (FIG. 3.15c) shows that, above the combined critical current of tapes 1 and 5, tape 3 takes up current more readily with the buffer layer than without it, bringing the current distribution into closer agreement with the experiment (FIG. 3.15b). This is because in the model the additional transverse y-direction resistance of the buffer layer restricts current flow through the face of the tapes and promotes current flow via tape-plane x-direction resistors through the upper and lower planes of the circuit into the edges of the tapes; this slightly improves current uniformity at intermediate operating currents, at the expense of some additional linear electric field. However, a discrepancy remains between the predictions of the model and the experimental measurements, which future work should seek to address. All model results outside this section continue to omit the buffer layer.

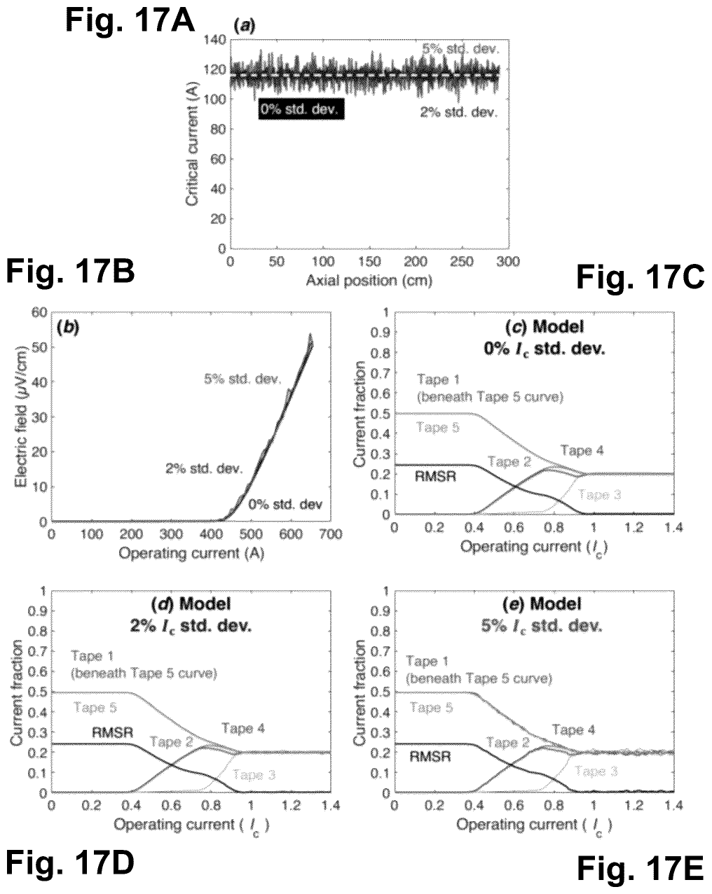

FIG. 17A is a plot of critical current as a function of axial position for model REBCO tape reels with baseline I_{c}=115.7 A and added Gaussian distribution (mean of 0 A; standard deviation 0%, 2%, and 5% of baseline c);

FIG. 17B shows a comparison of electric field at the axial midpoint of the cable as a function of operating current for the three I_{c} distribution cases (FIGS. 17C, 17D, 17E. Comparison of current distribution as a function of operating current at the 40 cm axial position for the three I_{c} distribution cases.

The model results presented throughout this document assume that all the REBCO tapes in the cable have identical individual self-field critical currents that are spatially uniform (except for local intentional defects), based on the mean critical current of several sacrificial samples from the tape reel used in the experiments. However, the critical current distribution of real-world tapes features natural spatial variations. The physical fidelity of the model described herein may be improved by modeling the spatial critical current distribution of the very tapes used in the experimental cable as measured by a reel-to-reel critical current measurement device, for example. To test this capability and to simulate the effect of a natural spatial critical current distribution, a Gaussian distribution of random numbers was added to the self-field critical current of each REBCO resistor in the circuit; the added distribution had a mean of 0 A and standard deviation of 2% or 5% of the baseline self-field critical current of 115.7 A, as shown in FIG. 17A. FIG. 17B compares the electric field at the axial midpoint of the cable as a function of operating current for the three critical current distribution cases, and FIGS. 17C-17E compare the current distribution as a function of operating current for the three cases.

These plots show that, while a spatial critical current distribution introduces some noise to the model results, the overall behavior of the cable is unchanged if the tapes have the same baseline self-field critical current. This demonstrates the robustness of the model in capturing the key aspects of cable behavior with an idealized critical current distribution. This also suggests that discrepancies between the model predictions and experimental results are not caused by local spatial critical current variations around a constant baseline, but may be due to longer length scale variations in critical current. Future work should use the measured reel-to-reel critical current distribution of the tapes used in the experimental cable to explore these effects in the model.

Various embodiments of the concepts, systems, devices, structures and techniques sought to be protected are described. It should, however, be appreciated that alternative embodiments can be devised without departing from the scope of the concepts, systems, devices, structures and techniques described herein. Controlling current flow with defects as described herein opens new capabilities in the design of HTS cables, HTS magnets and other HTS devices and structures, reducing their cost through more efficient utilization of HTS and enabling precise tuning of their performance. Defect-induced current control is of particular interest for small tape stacks in which reducing (and ideally minimizing) the dimensions and maximizing the range of available operating conditions is particularly important. Another commercial application of concepts, structures and techniques described herein is to enable HTS producers to increase their effective manufacturing yield by finding a new use for intrinsically defective tape sections.

It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

The term “direct contact” or “direct coupling” (and variants thereof) means that a first element, such as a first structure, and a second element, such as a second structure, are connected without intermediary structures at the interface of the two elements. As an example of an indirect positional relationship, references in the present description to forming or providing element or structure “A” over element or structure “B” include situations in which one or more intermediate elements or structures (e.g., element or structure “C”) is between element or structure “A” and element or structure “B” as long as the relevant characteristics and functionalities of element or structure “A” and element or structure “B” are not substantially changed by the intermediate element(s) or structure(s).

The following definitions and abbreviations are to be used for the interpretation of the claims and the specification. As used herein, the terms “comprises,” “comprising, “includes,” “including,” “has,” “having,” “contains” or “containing,” or any variations thereof, are intended to cover a non-exclusive inclusion. For example, a composition, a mixture, process, method, article, or apparatus (e.g. a device, component or system) that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration”. Any embodiment or design described herein as “exemplary” is not necessarily to be construed as preferred or advantageous over other embodiments or designs. The term “one or more” and “at least one” are understood to include any integer number greater than or equal to one, i.e. one, two, three, four, etc. The terms “a plurality” and “two or more” are understood to include any integer number greater than or equal to two, i.e. two, three, four, five, etc. The terms “connection” and “coupled” (including variants thereof) can include an indirect connection or indirect coupling as well as a direct connection or direct coupling. An indirect “connection” or indirect “coupling” means two elements or structures may be connected through one or more other elements or structures. A direct connection or direct coupling means two elements or structures are connected without any other elements or structures therebetween.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment.

Further, when a particular feature, structure, or characteristic is described in connection with an embodiment, it is submitted that it is within the knowledge of one skilled in the art to affect such feature, structure, or characteristic in connection with other embodiments whether explicitly described or not.

For purposes of the description hereinafter, the terms “upper,” “lower,” “right,” “left,” “vertical,” “horizontal, “top,” “bottom,” and derivatives thereof shall relate to the described elements, structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” “about,” “substantially” and “substantially equal” may be used to mean within ±20% of a target value in some embodiments, within ±10% of a target value in some embodiments, within ±5% of a target value in some embodiments, and yet within ±2% of a target value in some embodiments. The terms “approximately,” “about,” “substantially” and “substantially equal” may include the target value. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A high-temperature superconducting (HTS) cable comprising:
a plurality of HTS tapes each having a width, a thickness, a first surface and a second opposing surface, the plurality of HTS tapes arranged to provide an HTS tape stack with at least one of the plurality HTS tapes in the HTS tape stack having one or more selected portions thereof removed.

2. The HTS cable of claim 1 wherein locations of the one or more selected portions removed in the at least one of the plurality HTS tapes are selected to provide the HTS tape stack having a selected current carrying capacity characteristic.

3. The HTS cable of claim 1 wherein a location of each of the one or more selected portions removed from the at least one of the plurality HTS tapes is selected such that a current carrying capacity of the at least one of the plurality HTS tapes is reduced compared with a current carrying capacity of an HTS tape having no portions thereof removed.

4. The HTS cable of claim 1 wherein each of the at least one of the plurality HTS tapes has a selected portion thereof removed.

5. The HTS cable of claim 1 wherein at least one of the at least one of the plurality HTS tapes has a selected cross-section thereof removed.

6. The HTS cable of claim 1 wherein each of the at least one of the plurality HTS tapes has a selected cross-section thereof removed.

7. The HTS cable of claim 1 wherein each of the at least one of the plurality HTS tapes has all or a portion of a selected cross-section thereof removed to thereby reduce the current carrying capacity of the HTS tape compared with a current carrying capacity of an HTS tape having no portions thereof removed.

8. The HTS cable of claim 1 wherein each of the plurality of HTS tapes in the HTS tape stack has at least one selected portion thereof removed.

9. The HTS cable of claim 1 wherein each of the plurality HTS tapes in the HTS tape stack has all or a portion of a selected cross-section thereof removed to thereby reduce the current carrying capacity of the HTS tape.

10. The HTS cable of claim 1 wherein all or a portion of a cross-section of the at least one of the plurality HTS tapes is removed to reduce the current carrying capacity of the at least one of the plurality HTS tapes.

11. The HTS cable of claim 1 wherein selected portions of a cross-section of each of the at least one of the plurality HTS tapes is removed to reduce the current carrying capacity of each of the at least one HTS tape.

12. The HTS cable of claim 1 wherein selected portions of all or portions of a cross-section of the HTS tape stack is removed to thereby reduce the current carrying capacity of the HTS tape stack compared with a current carrying capacity of an HTS tape stack having no portions thereof removed.

13. The HTS cable of claim 1 wherein each of the plurality of HTS tapes are arranged such that each of the plurality of HTS tapes has at least one of the first and second surfaces contacting at least one of the first and second surfaces of another HTS tape in the HTS tape stack.

14. The HTS cable of claim 1 further comprising one or more conductive materials disposed between at least some surfaces of the HTS tapes in the HTS tape stack to fill regions where a surface of a first one of the plurality of HTS tapes in the HTS tape stack is not in contact with a surface of a second, different one of the plurality of HTS tapes in the HTS tape stack.

15. The HTS cable of claim 1 wherein the plurality of HTS tapes are secured together with solder.

16. A high-temperature superconductor (HTS) cable comprising:
a conductor having a channel provided therein; and
a plurality of HTS tapes arranged to provide an HTS tape stack with at least one of the HTS tapes having a portion thereof removed and wherein the HTS tape stack is disposed in at least a portion of the channel.

17. The HTS cable of claim 16 wherein all or part of a cross-section of one or more of the HTS tapes are mechanically removed to reduce the current carrying capacity of the tape compared with a current carrying capacity of an HTS tape having no portions thereof removed.

18. The HTS cable of claim 17 further wherein each of the plurality of HTS tapes arranged to provide an HTS tape stack has a cross-section thereof mechanically removed.

19. A method of shaping a current density characteristic of a high-temperature superconducting (HTS) cable, the method comprising:
selecting a plurality of HTS tapes;
determining a current density characteristic of each of the HTS tapes;
mechanically removing all or a part of a cross section of one or more of the plurality of HTS tapes; and
forming the plurality of HTS tapes into an HTS tape stack.

20. The method of claim 19 wherein removing all or a part of a cross section of one or more of the plurality of HTS tapes further comprises determining a location along a length of the one or more of the plurality of HTS tapes at which the all or part of a cross section is mechanically removed.
